(19) United States
(12) Patent Application Publication
(10) Pub. No.: US 2022/0358135 A1
(43) Pub. Date: Nov. 10, 2022

(54) SYSTEM AND METHOD FOR DATA AND DATA PROCESSING MANAGEMENT

(71) Applicant: Hitachi, Ltd., Tokyo (JP)

(72) Inventors: Yuya ISODA, Milpitas, CA (US); Kazuhide AIKOH, Santa Clara, CA (US)

(73) Assignee: Hitachi, Ltd.

(21) Appl. No.: 17/313,325

(22) Filed: May 6, 2021

(51) Int. Cl. G06F 16/25; G06F 16/23

(52) U.S. Cl. CPC G06F 16/25; G06F 16/2365

(57) ABSTRACT

Systems and methods described herein involve a meta-graph management configured to link external data source to another external data mart through a data management platform which can involve managing characteristics of one or more tables of the data source and the data mart and a temporary table based on columns, managing characteristics of one or more Input data and Output data of data processing from the data source to the data mart based on columns; managing relationships of characteristics between data and data processing for the data source and the data mart based on the columns; managing one or more data flows between the data source and the data mart that include data, data processing, and relationships; and providing data, data processing, and relationships between the data source and the data mart for each data flow.

### BACKGROUND

### Field

The present disclosure is generally directed to data management, and more specifically, to Ontology-based data management (OBDM).

### Related Art

While the amount of data stored in current information systems and the processes making use of such data continuously grow, turning these data into information, and governing both data and processes are still challenging tasks for Information Technology (IT). The problem is complicated by the proliferation of data sources and services both within a single organization, and in cooperating environments.

There are several factors regarding why such a proliferation constitutes a major problem with respect to the goal of carrying out effective data governance tasks. Firstly, although the initial design of a collection of data sources and services might be adequate, corrective maintenance actions tend to re-shape them into a form that often diverges from the original conceptual structure. Next, it is common practice in the related art to change a data source (e.g., a database) so as to adapt it both to specific application-dependent needs, and to new requirements. The result is that data sources often become data structures coupled to a specific application (or, a class of applications), rather than application independent databases. Further, the data stored in different sources and the processes operating over them tend to be redundant, and mutually inconsistent, mainly because of the lack of central, coherent and unified coordination of data management tasks.

The result is that information systems of medium and large organizations are typically structured according to a silos-based architecture, constituted by several, independent, and distributed data sources, each one serving a specific application. This poses great difficulties with respect to the goal of accessing data in a unified and coherent way. Analogously, processes relevant to the organizations are often hidden in software applications, and a formal, up-to-date description of what they do on the data and how they are related with other processes is often missing.

All the above observations show that a unified access to data and an effective governance of processes and services are extremely difficult goals to achieve in modern information systems. Yet, both are crucial objectives for getting useful information out of the data stored in the information system, as well as for taking decisions based on them. This explains why organizations spend a great deal of time and money for the understanding, the governance, the curation, and the integration of data stored in different sources, and of the processes/services that operate on them, and why this problem is often cited as a key and costly Information Technology challenge faced by medium and large organizations today.

Ontology-based data management (OBDM) is a promising direction for addressing the above challenges. The key idea of OBDM is to resort to a three-level architecture, constituted by the ontology, the sources, and the mapping between the two, where the ontology is a formal description of the domain of interest, and is the heart of the whole system. The distinction between the ontology and the data sources reflects the separation between the conceptual level, the one presented to the client, and the logical/physical level of the information system, the one stored in the sources, with the mapping acting as the reconciling structure between the two levels.

This separation brings several potential advantages. For example, the ontology layer in the architecture is the obvious mean for pursuing a declarative approach to information integration, and, more generally, to data governance. By making the representation of the domain explicit, we gain re-usability of the acquired knowledge. The mapping layer explicitly specifies the relationships between the domain concepts on the one hand and the data sources on the other hand. The ontology and the corresponding mappings to the data sources provide a common ground for the documentation of all the data in the organization, with obvious advantages for the governance and the management of the information system.

### SUMMARY

Aspects of the present disclosure can involve a method for a meta-graph management configured to link external data source to another external data mart through a data management platform, the method involving managing characteristics of one or more tables of the data source and the data mart and a temporary table based on columns; managing characteristics of one or more input data and output data of data processing from the data source to the data mart based on columns; managing relationships of characteristics between data and data processing for the data source and the data mart based on the columns; managing one or more data flows between the data source and the data mart that include data, data processing, and relationships; and providing data, data processing, and relationships between the data source and the data mart for each data flow.

Aspects of the present disclosure can involve a computer program for a meta-graph management configured to link external data source to another external data mart through a data management platform, the computer program involving instructions including managing characteristics of one or more tables of the data source and the data mart and a temporary table based on columns; managing characteristics of one or more input data and output data of data processing from the data source to the data mart based on columns; managing relationships of characteristics between data and data processing for the data source and the data mart based on the columns; managing one or more data flows between the data source and the data mart that include data, data processing, and relationships; and providing data, data processing, and relationships between the data source and the data mart for each data flow. The computer program can be stored on a non-transitory computer readable medium to be executed by one or more processors.

Aspects of the present disclosure can involve a system for a meta-graph management configured to link external data source to another external data mart through a data management platform, the system involving means for managing characteristics of one or more tables of the data source and the data mart and a temporary table based on columns; means for managing characteristics of one or more input data and output data of data processing from the data source to the data mart based on columns; means for managing relationships of characteristics between data and data processing for the data source and the data mart based on the columns; means for managing one or more data flows between the data source and the data mart that include data, data processing, and relationships; and means for providing data, data processing, and relationships between the data source and the data mart for each data flow.

Aspects of the present disclosure can involve an apparatus configured to facilitate a meta-graph management configured to link external data source to another external data mart through a data management platform, which can involve a processor configured to manage characteristics of one or more tables of the data source and the data mart and a temporary table based on columns; manage characteristics of one or more input data and output data of data processing from the data source to the data mart based on columns; manage relationships of characteristics between data and data processing for the data source and the data mart based on the columns; managing one or more data flows between the data source and the data mart that include data, data processing, and relationships; and provide data, data processing, and relationships between the data source and the data mart for each data flow.

### BRIEF DESCRIPTION OF DRAWINGS

FIG. 1 illustrates an example problem scenario related to silo-based data management.

FIG. 2 illustrates an example logical overview of the system in accordance with an example implementation.

FIG. 3 illustrates an overview of the meta-graph, in accordance with an example implementation.

FIGS. 4(A) to 4(E) illustrates an example diagram of components and data flows, in accordance with an example implementation.

FIGS. 5(A) and 5(B) illustrate example tables and sample data, in accordance with an example implementation.

FIG. 6 illustrates an example of meta-graph management for table, in accordance with an example implementation.

FIG. 7 illustrates an example of meta-graph management for data processing, in accordance with an example implementation.

FIG. 8 illustrates an example of the data flow format managed by the search log, execution log, execution configuration, and autorun configuration, in accordance with an example implementation.

FIG. 9 illustrates the example algorithm execution of the data source search engine, in accordance with an example implementation.

FIG. 10 illustrates an example interface of the data source engine, in accordance with an example implementation.

FIGS. 11(A) and 11(B) illustrate an example flow diagram for the data source search engine, in accordance with an example implementation.

FIG. 12 illustrates an example of a graphical user interface (GUI) of the data search engine for displaying the execution result for each data flow, in accordance with an example implementation.

FIG. 13 illustrates an example user interface when a user clicks on the table, in accordance with an example implementation.

FIG. 14 illustrates examples of table properties managed by the meta-graph, in accordance with an example implementation.

FIG. 15 illustrates an example user interface displaying the data processing properties when the user clicks on the data processing, in accordance with an example implementation.

FIG. 16 illustrates an example user interface displaying the relationship properties when the user clicks on the relationship, in accordance with an example implementation.

FIG. 17 illustrates an example interface for the execution properties when the user clicks on the data flow and the execution tab, in accordance with an example implementation.

FIG. 18 illustrates an example flow diagram for the data flow execution engine, in accordance with an example implementation.

FIG. 19 illustrates an example of execution log when the user clicks on the data processing and the log tab, in accordance with an example implementation.

FIG. 20 illustrates examples of data flow properties and costs determined from the cost calculator, in accordance with an example implementation.

FIG. 21 illustrates an example of the autorun settings when the user clicks on the data flow and the autorun tab, in accordance with an example implementation.

FIG. 22 illustrates an example of meta-graph with autorun settings, in accordance with an example implementation.

FIG. 23 illustrates an example flow diagram of the data flow autorun engine, in accordance with an example implementation.

FIG. 24 illustrates an example interface for the data mart search engine, in accordance with an example implementation.

FIGS. 25(A) and 25(B) illustrate an example flow diagram for the data mart search engine, in accordance with an example implementation.

FIG. 26 illustrates an example of a data flow recommendation engine, in accordance with an example implementation.

FIGS. 27(A) and 27(B) illustrate example aspects of the data flow recommendation engine, in accordance with an example implementation.

FIG. 28 illustrates an example interface of the data flow properties with the recommendation node, in accordance with an example implementation.

FIG. 29 illustrates an example creation of the data processing from the recommendation, in accordance with an example implementation.

FIG. 30 illustrates a system involving a plurality of systems with connected sensors and a management apparatus, in accordance with an example implementation.

FIG. 31 illustrates an example computing environment with an example computer device suitable for use in some example implementations.

### DETAILED DESCRIPTION

The following detailed description provides details of the figures and embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Embodiments as described herein can be utilized either singularly or in combination and the functionality of the embodiments can be implemented through any means according to the desired implementations.

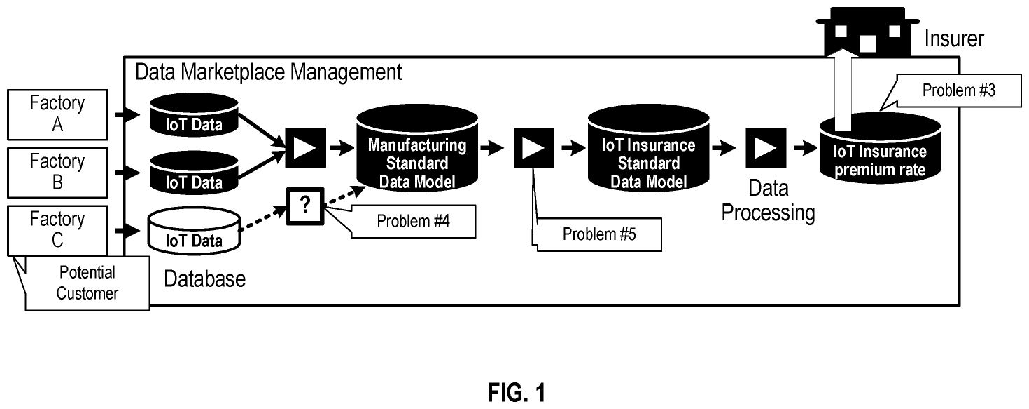

FIG. 1 illustrates an example problem scenario related to data management. In this example, suppose there are several factories providing Internet of Things (IoT) data to a data marketplace management system. The IoT data is processed by a Manufacturing Standard Data Model to determine the status of the factories, which can then be processed by an IoT insurer through an IoT Insurance Standard Data Model, the output of which helps to determine appropriate insurance rates by the IoT insurer.

The IoT insurer desires to scale the business and increase customers, and therefore needs to reach out to potential customers. Even if the IoT insurer wishes to search for potential customers, they do not have access to any relevant data to determine potential customers. If the IoT insurer wishes to provide an insurance premium rate from the data for potential customers, the IoT insurer may not understand what data processing techniques to use for the new customers while desiring to use present data processing for the new customers. Similarly, a factory owner may desire to sign up for IoT insurance and may not know what IoT insurance applies to his data, how to reach the IoT insurance services, what data processing is needed to obtain IoT insurance, and the costs of the IoT insurance.

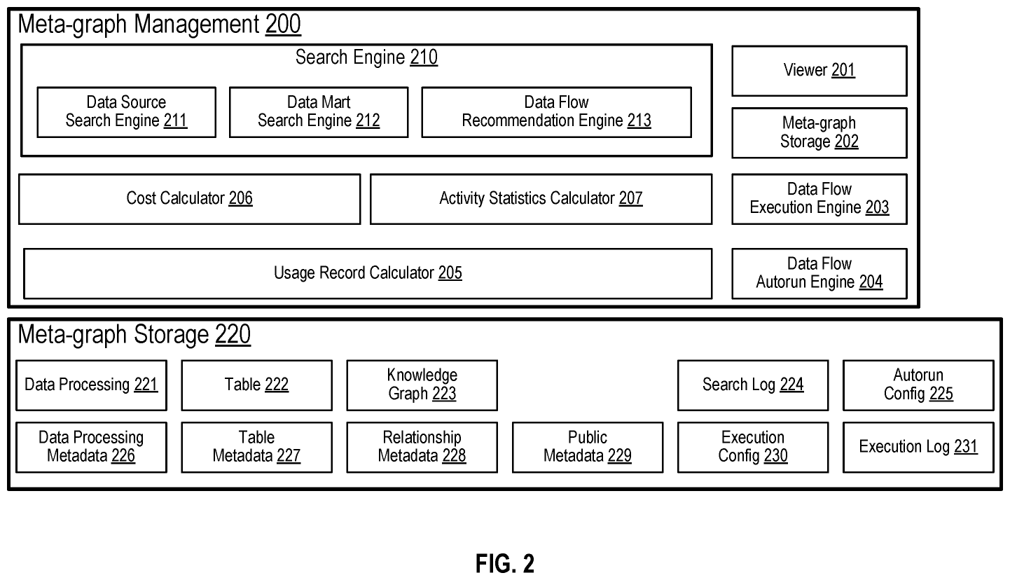

FIG. 2 illustrates an example logical overview of the system in accordance with an example implementation. Meta-graph management 200 can involve a viewer 201, a meta-graph storage 202, a data flow execution engine 203, a data flow autorun engine 204, a usage record calculator 205 configured to calculate usage from using metadata, execution log 231, execution configuration 230 and autorun configuration 225, a cost calculator 206 configured to calculate costs from using metadata and execution log 231, an activity statistics calculator 207 configured to calculate activity statistics from the metadata and the execution log 231, and search engine 210. The search engine 210 can involve a data source search engine 211, a data mart search engine 212, and a data flow recommendation engine 213.

Meta-graph storage 220 can involve data processing 221, table 222, knowledge graph 223, search log 224, autorun configuration 225, various metadata such as data processing metadata 226, table metadata 227, relationship metadata 228, and public metadata 229, as well as execution configuration 230 and execution log 231. Further details of these elements are described with respect to the implementations herein.

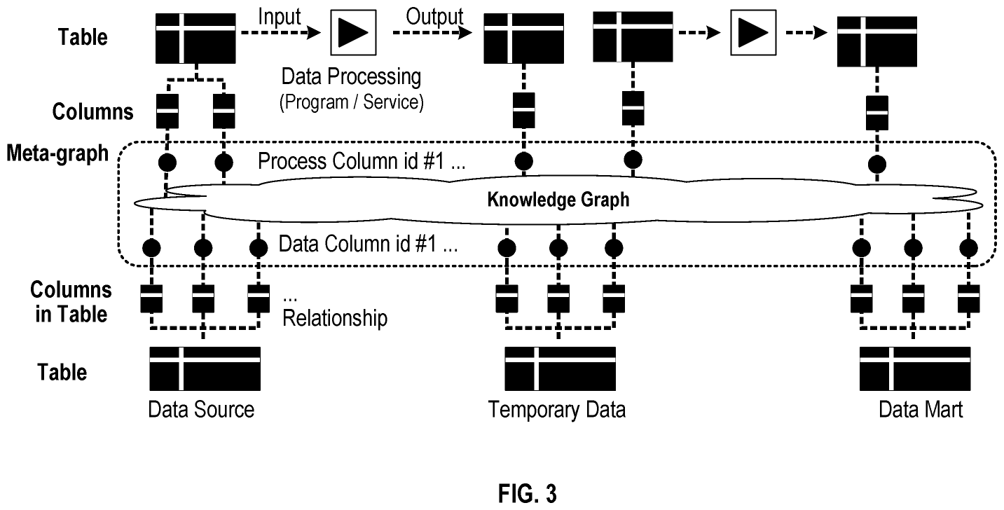

FIG. 3 illustrates an overview of the meta-graph, in accordance with an example implementation. Specifically, the meta-graph manages relationships between data and data processing based on each column by using GraphDB, and manages input and output tables for data processing. The knowledge graph stores information in Resource Description Framework (RDF) format, and example implementations herein are explained with respect to RDF format for ease of understanding. In example implementations, the RDF-modeled Competency Index for Linked Data is used to provide a means for mapping learning resources descriptions to the competencies those resources address to assist in finding, identifying, and election resources appropriate to specific learning needs.

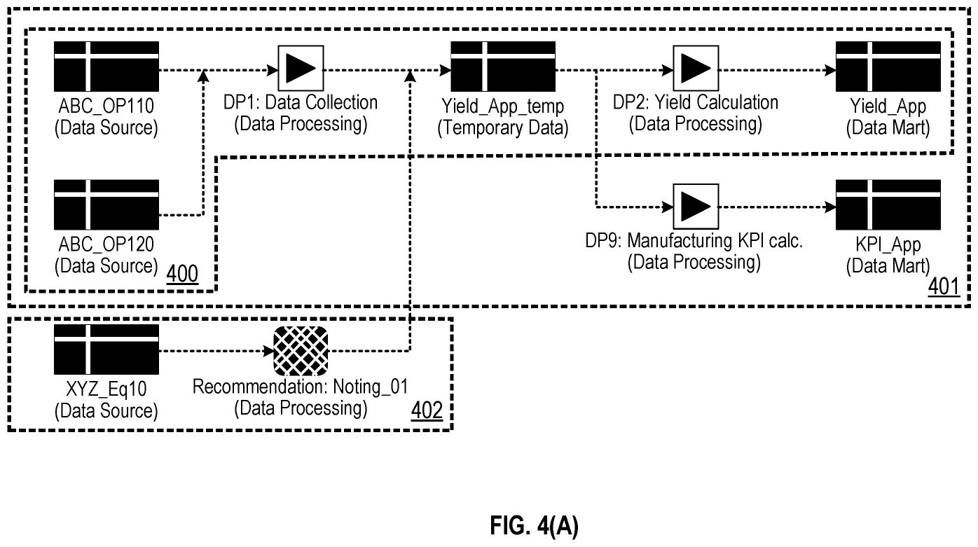

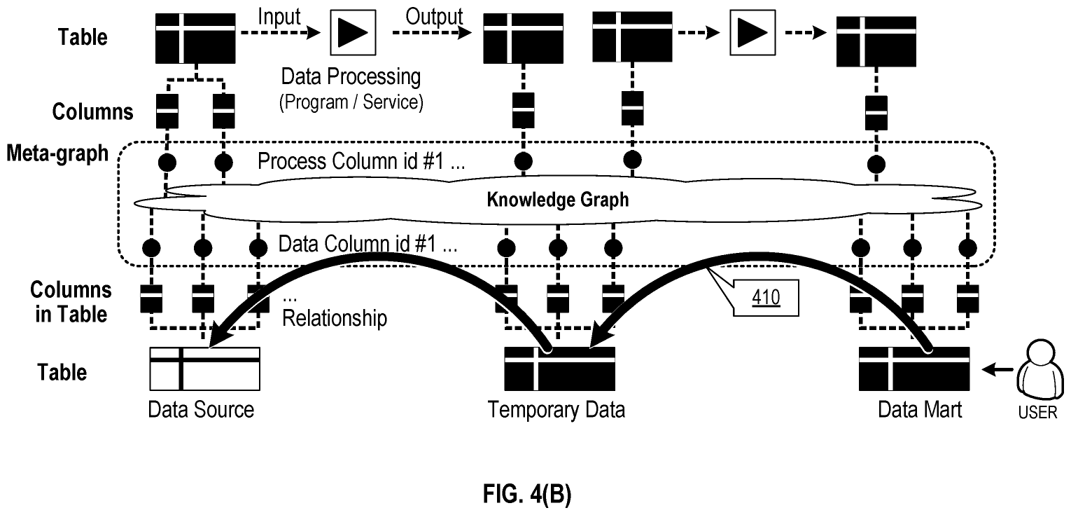

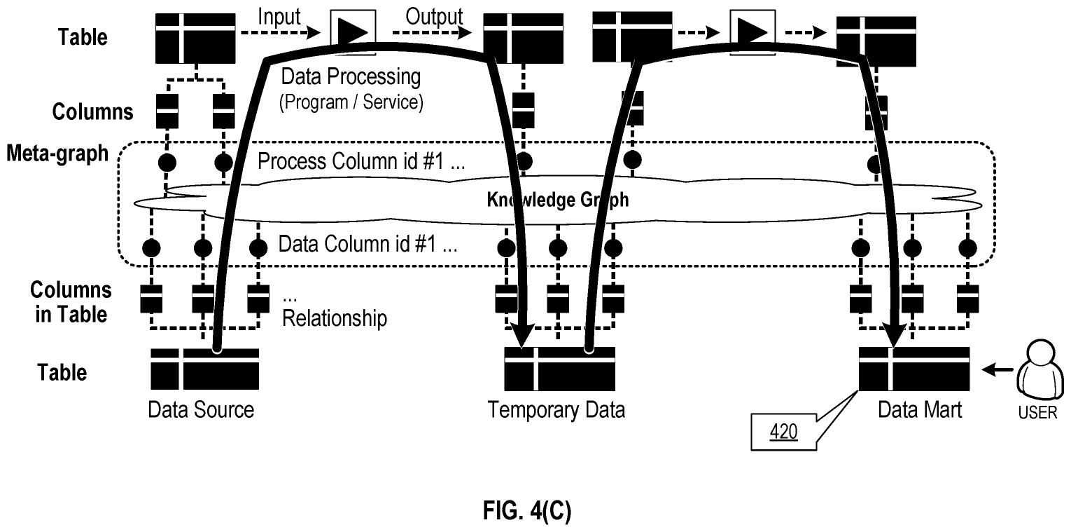

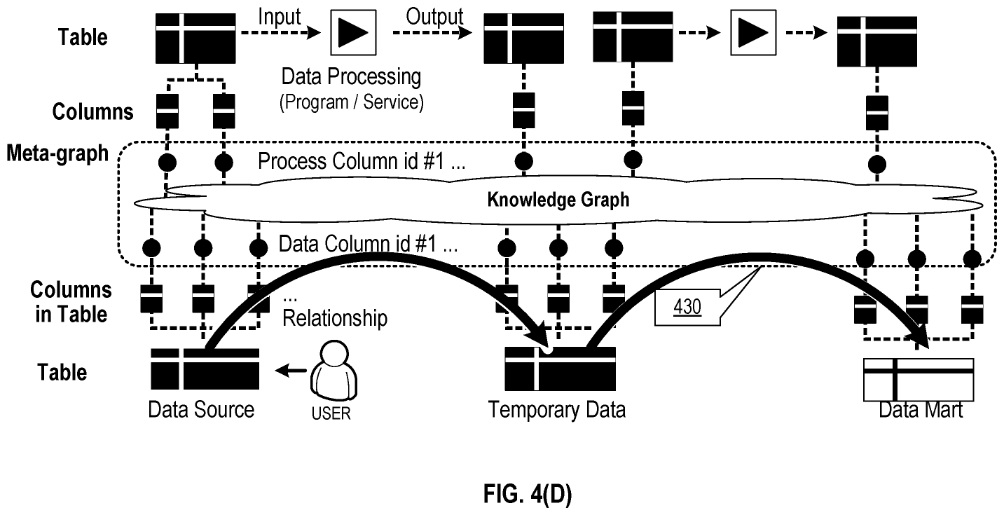

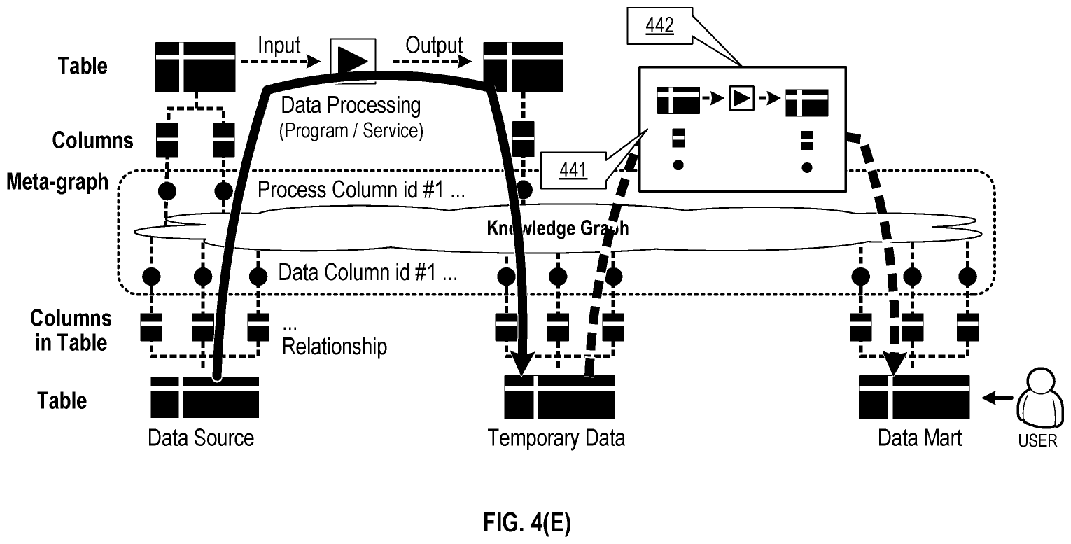

FIGS. 4(A) to 4(E) illustrates an example diagram of components and data flows, in accordance with an example implementation. In this example, assume there are three data sources, three data processing, one temporary data and two data marts. Referring to FIG. 3, example implementations utilize three main components which are data tables, data processing, and meta-graph. In a first scenario 400, users discover data sources form a data mart. The meta-graph manages relationships between data and data processing based on column information (meta-data). Users can search for data sources and data marts in both directions (e.g., data mart ←→ temporary data ←→ data source via meta-graph as illustrated at the data flow 410 for finding data sources in FIG. 4(B)) by using meta-graph.

In a second scenario 401, users create a data mart from data sources. In this scenario, user defines the data flow and executes the data flow to get a data mart as illustrated in the data flow 420 at FIG. 4(C).

In a third and fourth scenario 402, users discover data marts from a data source and users clarify the missing relationships and get a support to create the missing node. In the third scenario as illustrated in FIG. 4(D) there is a data flow 430 to search for the data mart. In the fourth scenario as illustrated in FIG. 4(E), if the meta-graph has the missing relationships between a data source and a data mart, users cannot create a data flow. Accordingly, users can clarify the missing relationships 440 and get support to create the missing relationships.

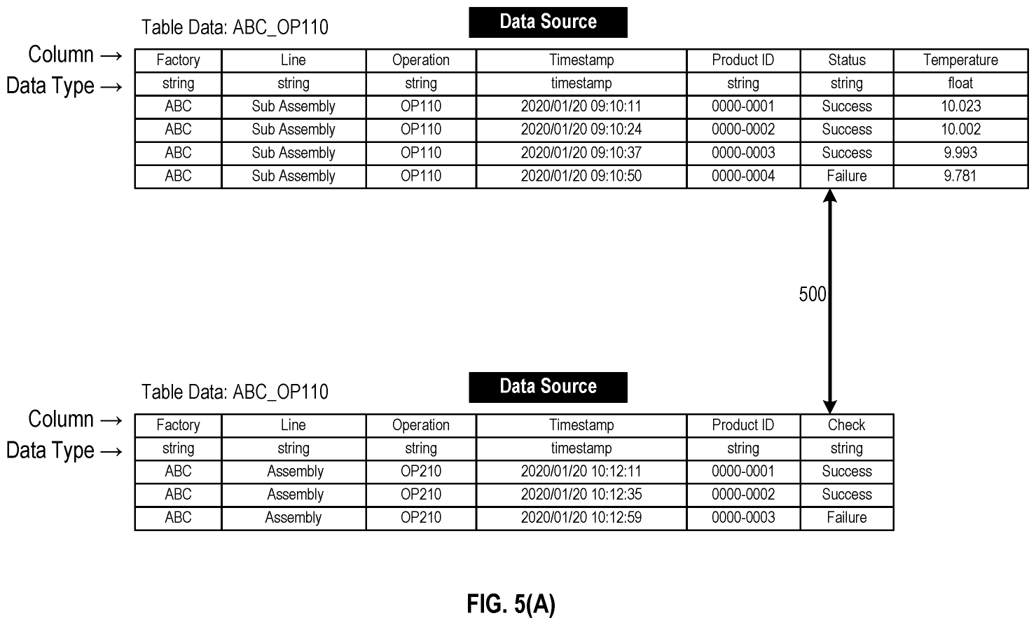

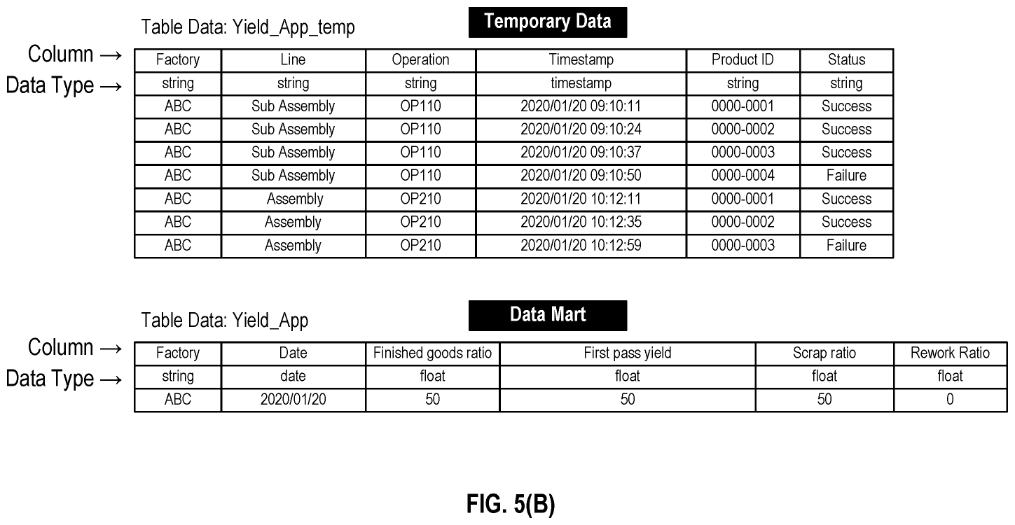

FIGS. 5(A) and 5(B) illustrate example tables and sample data, in accordance with an example implementation. Specifically, FIG. 5(A) illustrates two examples of data tables in which the column names are different, but they actually have the same meaning as illustrated at 500. In example implementations, the meta-graph uses GraphDB (including the knowledge graph) to connect the metadata relationships for these columns. FIG. 5(B) illustrates example data for the temporary data and the data mart.

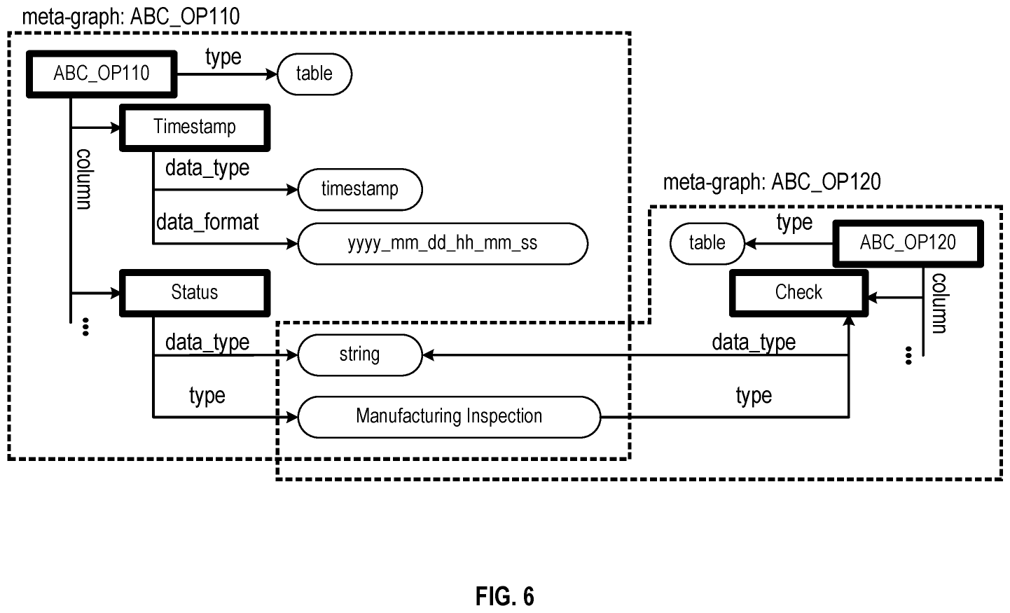

FIG. 6 illustrates an example of meta-graph management for table 222, in accordance with an example implementation. The meta-graph has the ability to manage the relationship between data and data processing based on column. In this example implementation the meta-graph manages the relationships of column metadata for each table. The met-graph can manage the metadata relationships and the relationships between data and data processing based on RDF format. It is not important that the columns have the same name as opposed to having the same attributes, the same meaning, the same language, and the same data type. If the attributes/meaning/language/data type are the same, then the same data processing can be applied to such data.

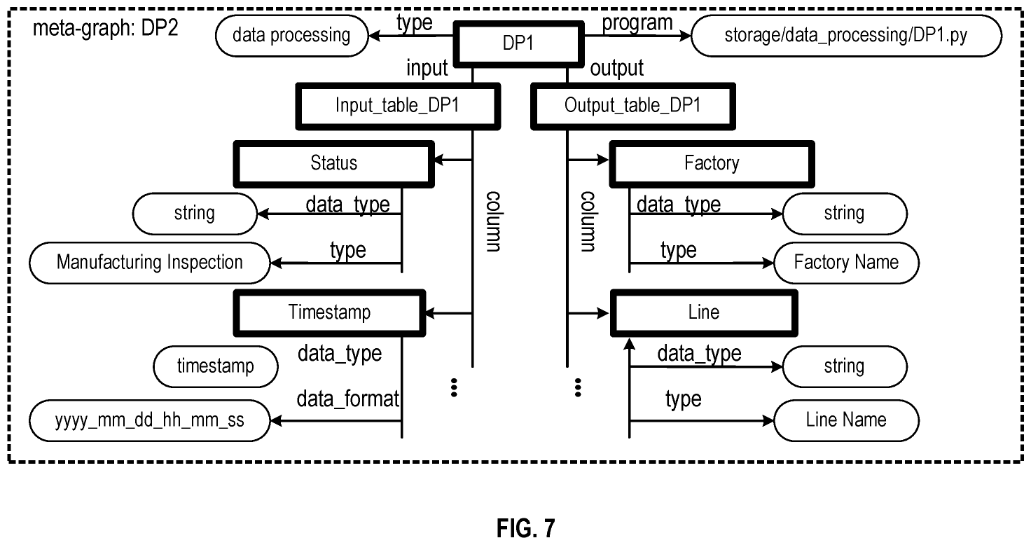

FIG. 7 illustrates an example of meta-graph management for data processing 221, in accordance with an example implementation. In example implementations, the meta-graph has the ability to manage the input and output tables of data processing based on column. The meta-graph manages the relationships between a table and an input table of data processing.

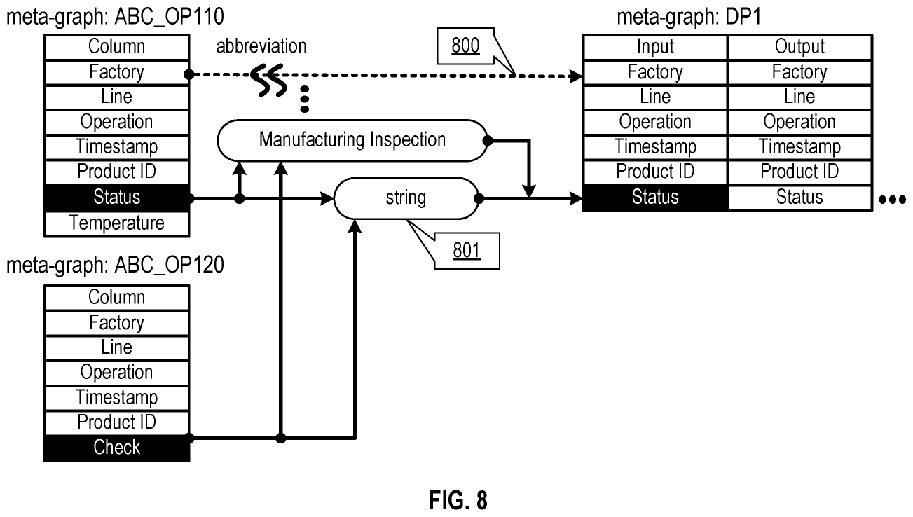

FIG. 8 illustrates an example of the data flow format managed by the search log 224, execution log 231, execution configuration 230, and autorun configuration 225, in accordance with an example implementation. Meta-graph generally creates a data flow for each data mart, as illustrated in FIG. 8. The data flow is indicative of the relationships between a data source and a data mart. A data flow generally has relationships between 1 . . . N data sources and a data mart. In example implementations, the meta-graph manages column-to-column relationships in directed graphs by using the knowledge graph. For example, the meta-graph connects the relationships between table of ABC_OP110 and data processing of DP1 through a directed graph 800. Further, the meta-graph connects the relationships between table of ABC_OP120 and data processing of DP1 at 801 as well through the use of a knowledge graph. In this case, DP1 has input data for ABC_OP110 and ABC_OP120. Even if these column names are different, DP1 can execute the data processing for each table using the relationship.

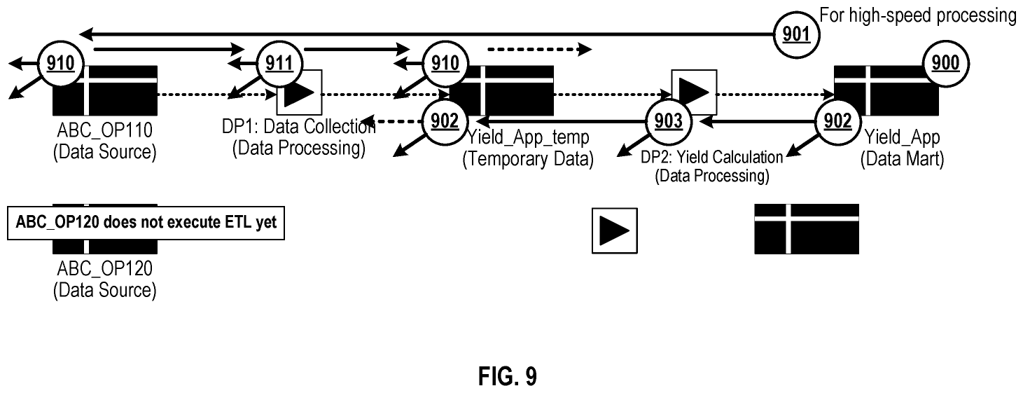

In the following examples from FIGS. 9 to 16, the first scenario of FIG. 4(B) is illustrated.

FIG. 9 illustrates the example algorithm execution of the data source search engine, in accordance with an example implementation. The data source search engines are used to search for data sources from a data mart. At 900 first, user defines a root table to search for data sources. The engine then searches for execution logs to trace data flows from the data mart to data sources. At 901, if this engine detects log files, this engine conducts a depth first search for data flows from data sources to the data mart based on the log files as shown at 910 and 911. The execution log is the data flow of the data processing execution log. Therefore, this engine makes it easy to find the data flow of a defined data mart. If the engine cannot detect log files, then the engine conducts a breadth first search for data flows from the data mart to data sources as shown at 902 and 903. Specifically, the search engine searches for relationships between data processing “output” and the table as shown at 902, and searches for relationships between data processing “input” and tables as shown at 903. The process at 902 and 903 is executed recursively until a data source is located.

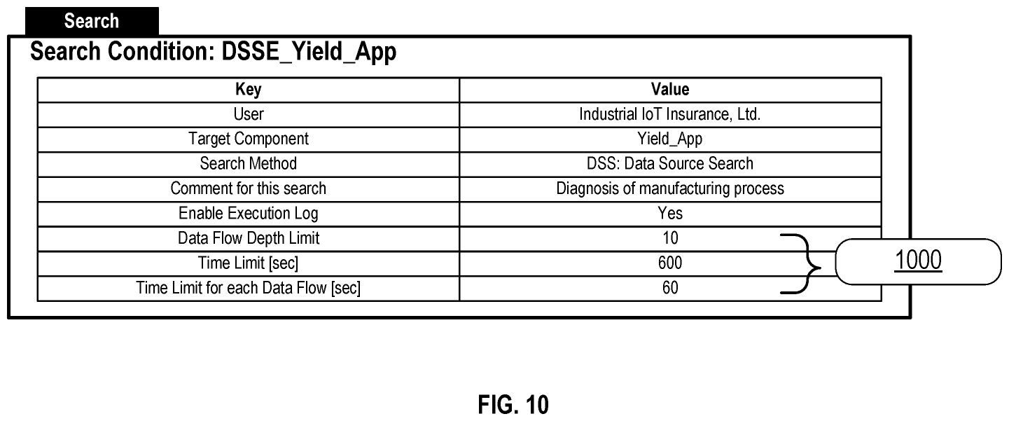

FIG. 10 illustrates an example interface of the data source engine, in accordance with an example implementation. In the example interface, the user can determine the search scope, and utilize the execution log, and can set the account, target component, search method, and so on in accordance with the desired implementation. As illustrated at element 1000, the user can define the search conditions (e.g., data flow depth limit, time limit, time limit/data flow, etc.) to limit the execution time. Further, if the data source search engine utilizes the execution log, the data source search engine will thereby search for relationships between the table and data processing from data sources to the root table by utilizing execution logs.

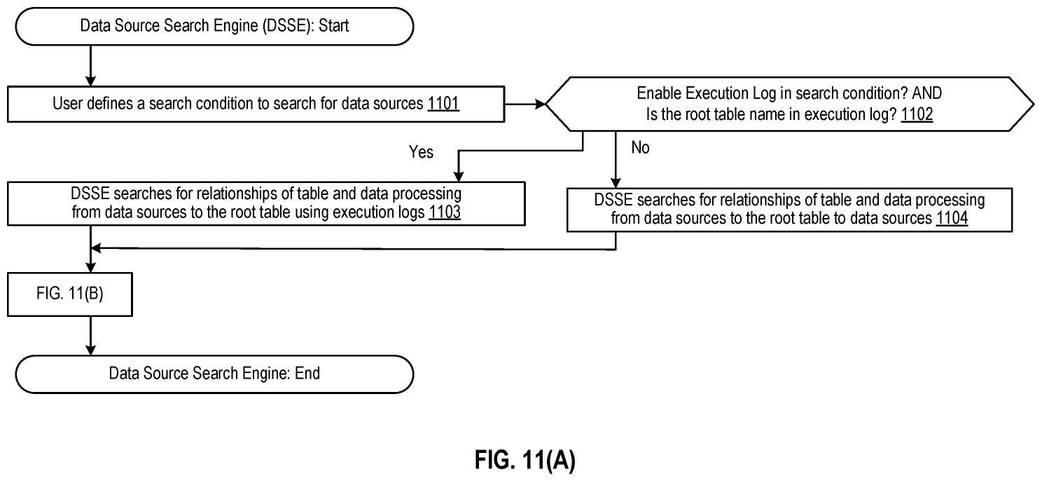

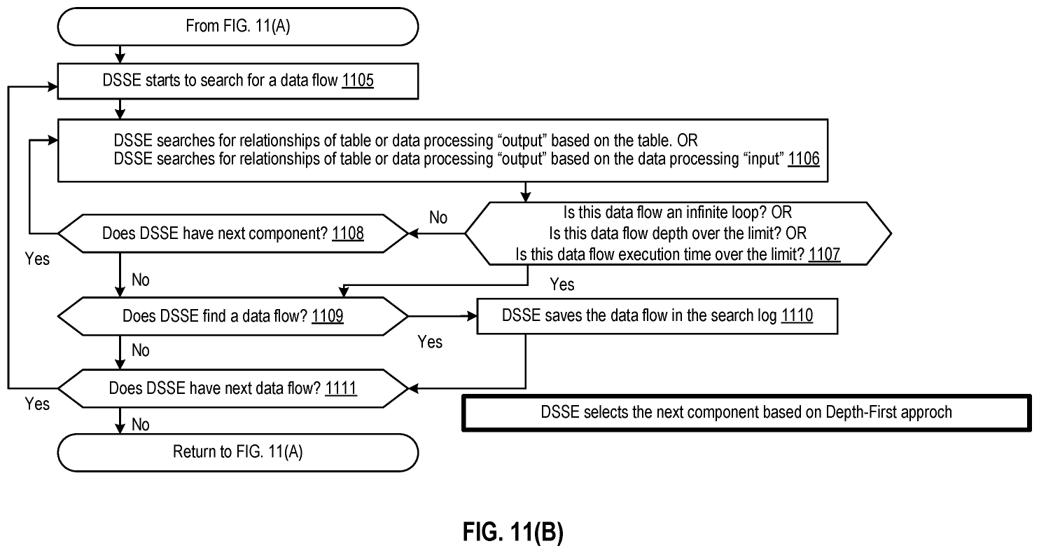

FIGS. 11(A) and 11(B) illustrate an example flow diagram for the data source search engine, in accordance with an example implementation. The flow starts at 1101, wherein the user defines a search condition to search for data sources. At 1102, a determination is made as to whether the execution log is enabled in the search condition and the root table name is in the execution log. If so (Yes), then the flow proceeds to 1103 wherein the data source search engine searches for relationships of table and data processing from data sources to the root table by using the execution logs. Otherwise (No), then the flow proceeds to 1104 to search for relationships of table and data processing from data sources to the root table to data sources.

At 1105, the data source search engine executes a search for a data flow. At 1106, the data source search engine searches for relationships of table or data processing “output” based on the table, or it searches for relationships of table or data processing “output” based on the data processing “input”. The data source engine does not only extract exact matches, but can also be modified to extract similar relationships through the use of machine learning (e.g., topic modeling, clustering, etc.) in accordance with the desired implementation.

At 1107, the data source search engine determines if the data flow is an infinite loop, if the data flow depth over the limit, or if the data flow execution time over the limit. If not (No), the flow proceeds to 1108, otherwise (Yes) the flow proceeds to 1109. At 1108, the data source search engine selects the next component to process based on a depth-first search approach. If there is a component to process (Yes), then the flow proceeds to 1106 to process the component, otherwise (No), the flow proceeds to 1109.

At 1109 if a data flow was found, then the process proceeds to 1110 to save the data flow in the search log. At 1111, if there is an additional data flow to be found (Yes), then the process repeats at 1106, otherwise (No), the process ends.

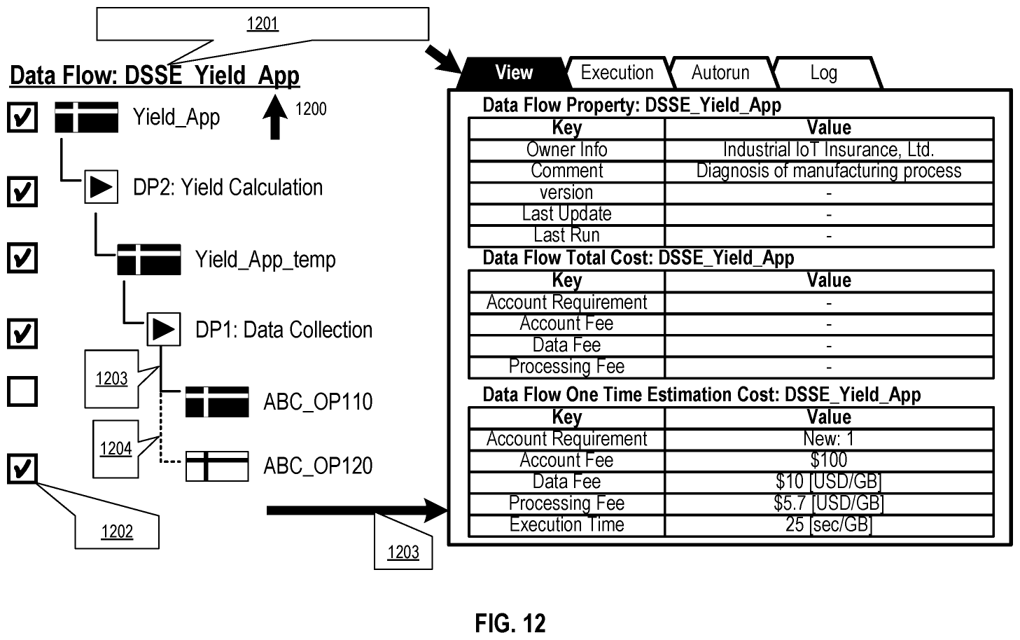

FIG. 12 illustrates an example of a graphical user interface (GUI) of the data search engine for displaying the execution result for each data flow, in accordance with an example implementation. In this example, the user clicks 1200 on the data flow, whereupon the GUI displays the properties of the data flow as shown at 1201. In this example, the search engine found a data flow, whereupon the viewer reads the flow from the search log.

In an example implementation, the estimated cost for data processing can be automatically calculated based on a selection of an execution target using execution logs. In this example, the user selects an execution target at 1202. Based on the selection, a calculation and estimation of the cost is conducted at 1203, with the results as shown for the data fee and the processing fee.

In the example of FIG. 12, the viewer can provide the relationships of the data flows. For example, at 1203, the viewer can display a solid line if the relationship is already in use based on the execution log, and at 1204, the viewer can provide a dashed line if the relationship has not yet been used based on the execution log.

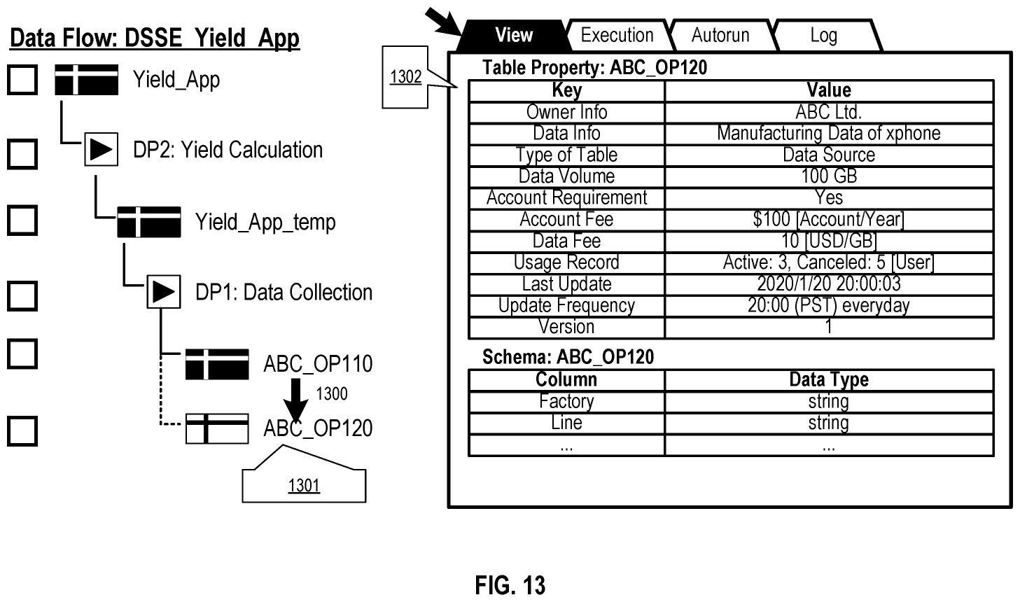

FIG. 13 illustrates an example user interface when a user clicks on the table, in accordance with an example implementation. Specifically, FIG. 13 illustrates examples of properties when the user clicks on the table. These properties are managed by the meta-graph. In this example, when the user clicks on the table at 1300, the data source search engine has found ABC_OP120 table for importing new data into the data mart (Yield_App) at 1301. At 1302, the meta-graph manages the display properties of ABC_OP120. Further, as illustrated in FIG. 13, the viewer can also calculate usage records based on the execution log.

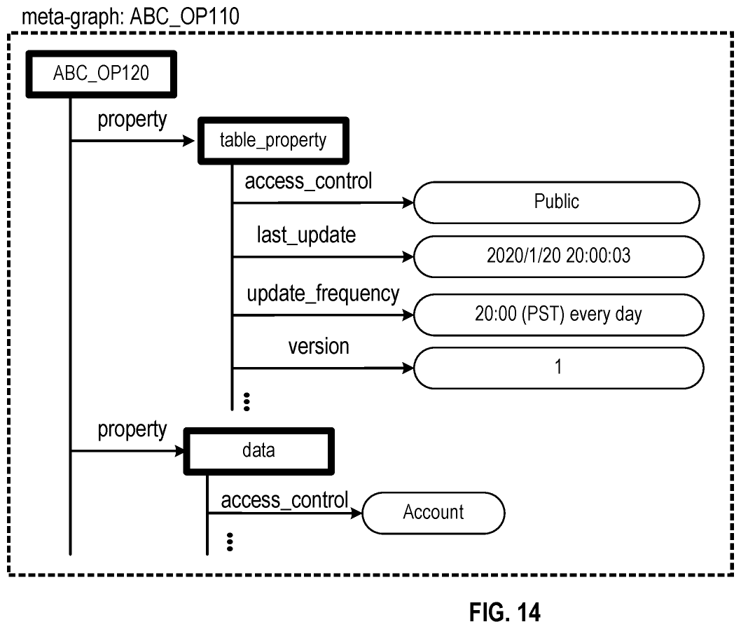

FIG. 14 illustrates examples of table properties managed by the meta-graph, in accordance with an example implementation. Specifically, FIG. 14 illustrates the example management of the display properties of ABC_OP120 by meta-graph.

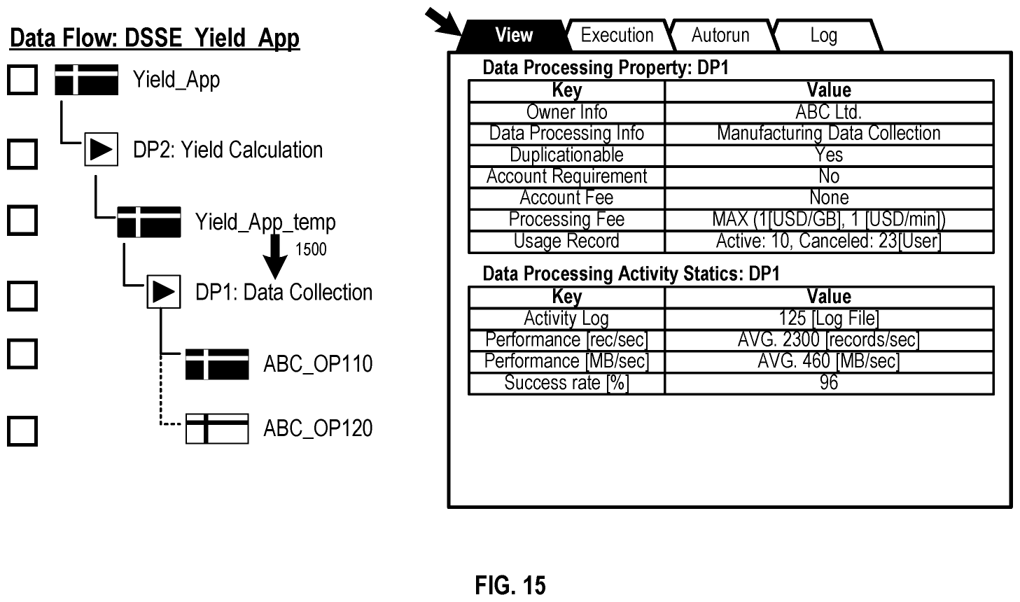

FIG. 15 illustrates an example user interface displaying the data processing properties when the user clicks on the data processing 1500, in accordance with an example implementation. In the example of FIG. 15, the duplicationable field indicates whether duplication of the data processing program is approved or not. For example, encryption programs are difficult to duplicate across national borders due to data laws. If “Data Processing Duplication” of Data Flow Execution Property is Yes AND “Duplicationable” of Data Processing Property is Yes, the interface duplicates the data processing of the data flow to avoid data conflict and security risk.

In the example of FIG. 15, meta-graph manages the display properties in the meta-graph and the activity statistics (e.g., success rate, etc.) is calculated from logs (e.g., execution log, execution configuration, autorun configuration, etc.). In this example, the viewer calculates the activity statistics based on the execution log.

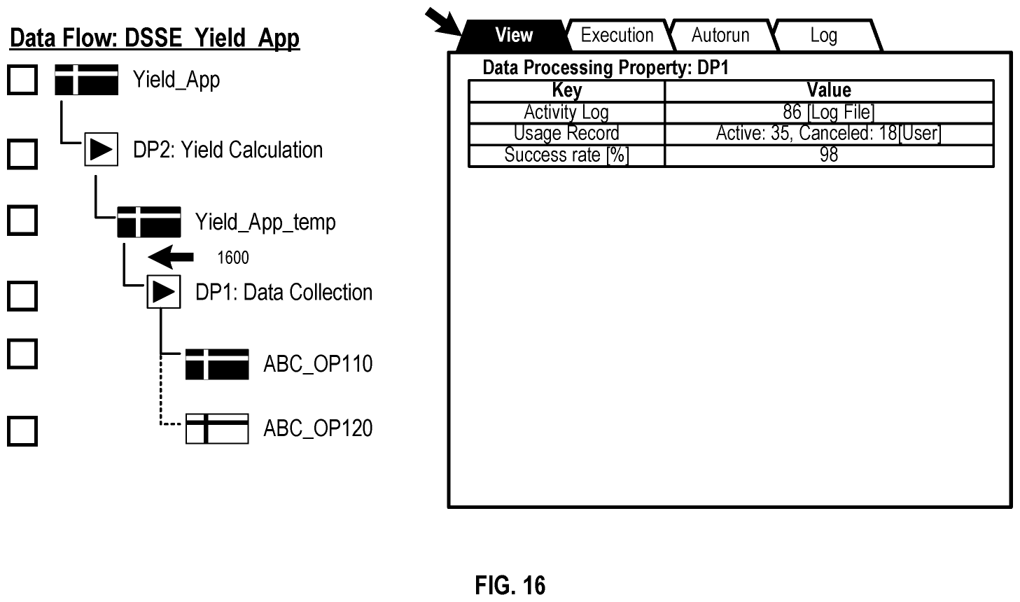

FIG. 16 illustrates an example user interface displaying the relationship properties when the user clicks on the relationship 1600, in accordance with an example implementation. Specifically, the properties are calculated from the logs (e.g., execution logs, execution configuration, autorun configuration, etc.). In the example of FIG. 16, a relationship property is illustrated based on the execution log.

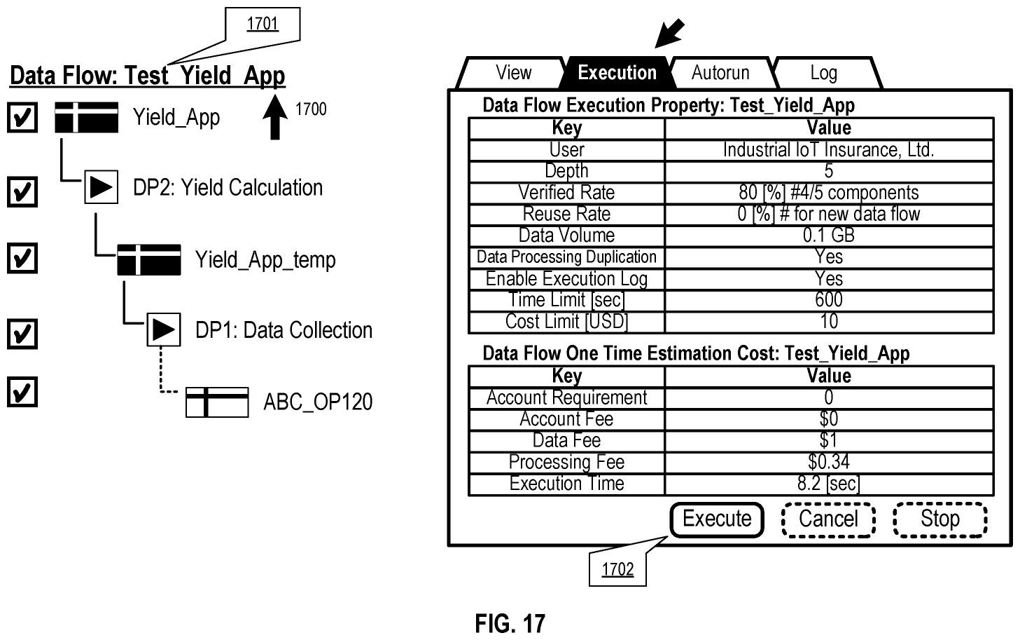

In the following explanations for FIGS. 17 to 23, the second scenario of FIG. 4(C) is illustrated.

FIG. 17 illustrates an example interface for the execution properties when the user clicks on the data flow and the execution tab 1700, in accordance with an example implementation. The properties are set by the user, but can also be set through other techniques in accordance with the desired implementation. The validated rate indicates the percentage of successful activities in the data flow. The reuse rate indicates the percentage of reuse components in the data flow. In the example of FIG. 17, the user creates a new data flow, so the reuse rate is 0%. The properties are calculated from execution logs based on the data volume.

In the example of FIG. 17, the user renames “DSSE_Yield_App” to “Test_Yield_App” for testing purposes at 1701, wherein the user can execute the application if the data path is established at 1702.

Further, the viewer calculates a verified rate of data flow components and a reuse rate as illustrated in FIG. 17. In addition, if “Data Processing Duplication” of Data Flow Execution Property is Yes AND “Duplicationable” of Data Processing Property is Yes, then the data flow execution engine duplicates the data processing of the data flow to avoid data conflict and security risk.

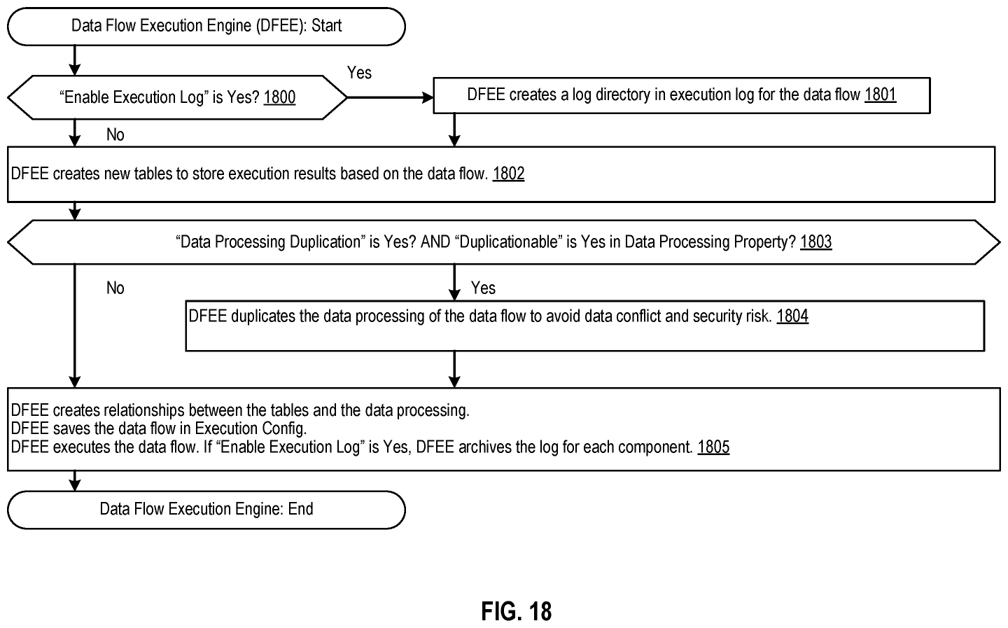

FIG. 18 illustrates an example flow diagram for the data flow execution engine, in accordance with an example implementation. Specifically, FIG. 18 illustrates two main aspects of the data flow execution engine. Firstly, the engine creates new tables to store an execution result based on the data flow, as there can be data conflicts when applications use the same table. Accordingly, the data flow execution engine creates the table to avoid such a problem. Secondly, the data flow execution engine duplicates the data processing of the data flow to avoid data conflicts and security risk. If there are no conflicts or security risks, then the data flow can use the original data processing managed by another user. For example, encryption programs are difficult to duplicate across national borders under the law. The engine executes the data flow and archives log files for each component. Accordingly, this engine creates tables to avoid such a problem.

At 1800, a determination is made as to whether “Enable Execution Log” is set to Yes. If so, (Yes), then the flow proceeds to 1801, otherwise (No), the flow proceeds to 1802. At 1801, the data flow execution engine creates a log directory in execution log for the data flow. At 1802, the data flow execution engine creates new tables to store execution results based on the data flow. There can be data conflicts when applications use the same table, so the data flow execution engine creates new tables to avoid such problems at 1802. At 1803, a determination is made as to whether “Data Processing Duplication” is Yes? AND “Duplicationable” is Yes in Data Processing Property. If so (Yes), then the data flow execution engine proceeds to 1804 to duplicate the data processing of the data flow to avoid data conflict and security risk. Otherwise (No), the data flow utilizes the original data processing managed by another user.

At 1805, the data flow execution engine creates relationships between the tables and the data processing. The engine creates and saves the data flow in the Execution Config and executes the data flow. Further, if “Enable Execution Log” is Yes, the data flow execution engine archives the log for each component.

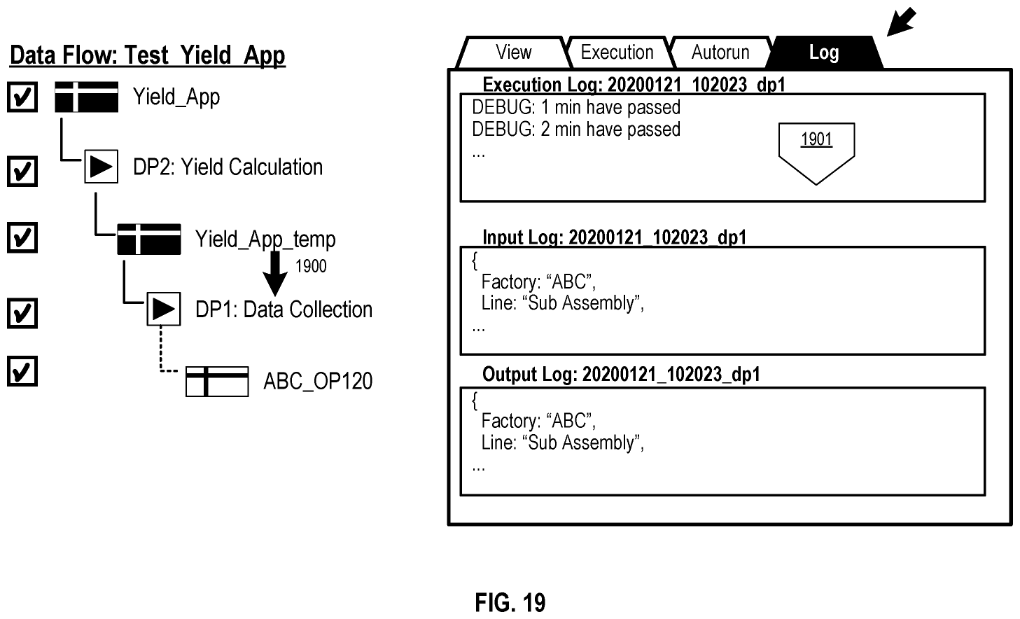

FIG. 19 illustrates an example of execution log when the user clicks on the data processing 1900 and the log tab, in accordance with an example implementation. Specifically, the viewer displays log properties by using execution logs 1901, and the user checks the program log, input data, and output data.

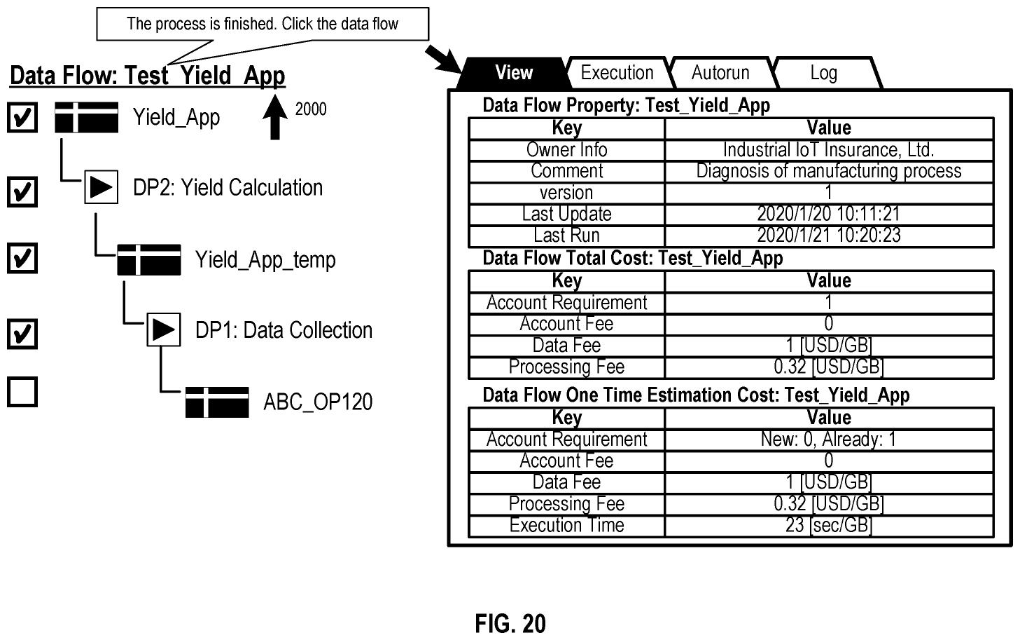

FIG. 20 illustrates examples of data flow properties and costs determined from the cost calculator, in accordance with an example implementation. Specifically, the viewer calculates an estimate cost and a total cost based on the selection 2000 of execution target. In this case, the viewer can calculate the total cost of this data flow because it has been processed, whereupon a pop-up can be produced to indicate “The process is finished. Click the data flow.” The cost calculator can then calculate the cost by using the execution log.

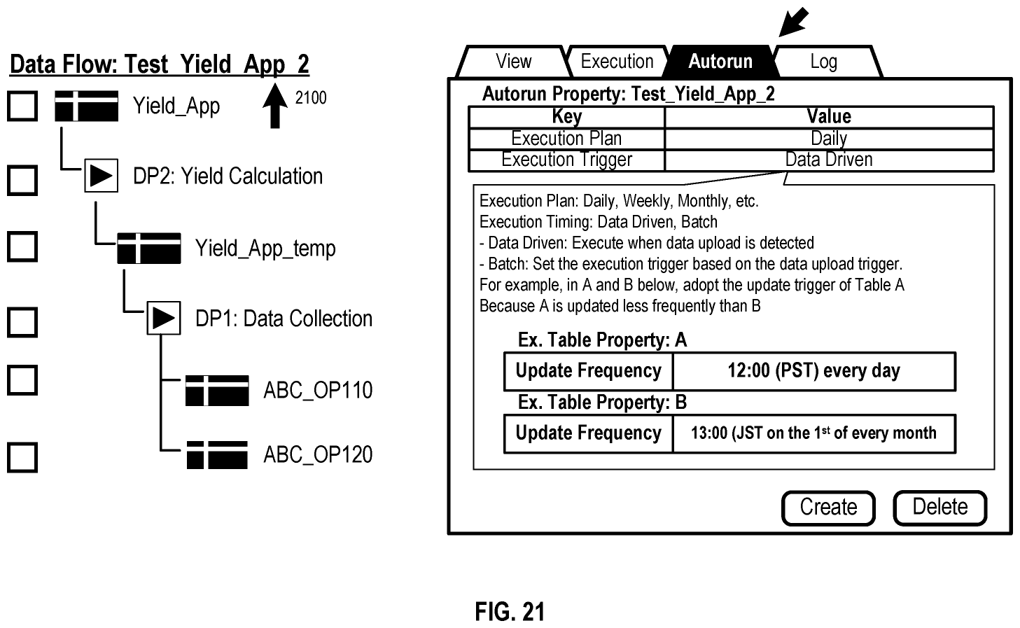

FIG. 21 illustrates an example of the autorun settings when the user clicks on the data flow and the autorun tab 2100, in accordance with an example implementation. The users can choose data-driven or batch scheduling to define execution triggers. Then, the user clicks on the create button. In example implementations, the data flow autorun engine creates event triggers for the data flow. The data flow autorun engine creates new event trigger in the data source table, or the data flow autorun engine creates a batch trigger based on “Update Frequency” of tables.

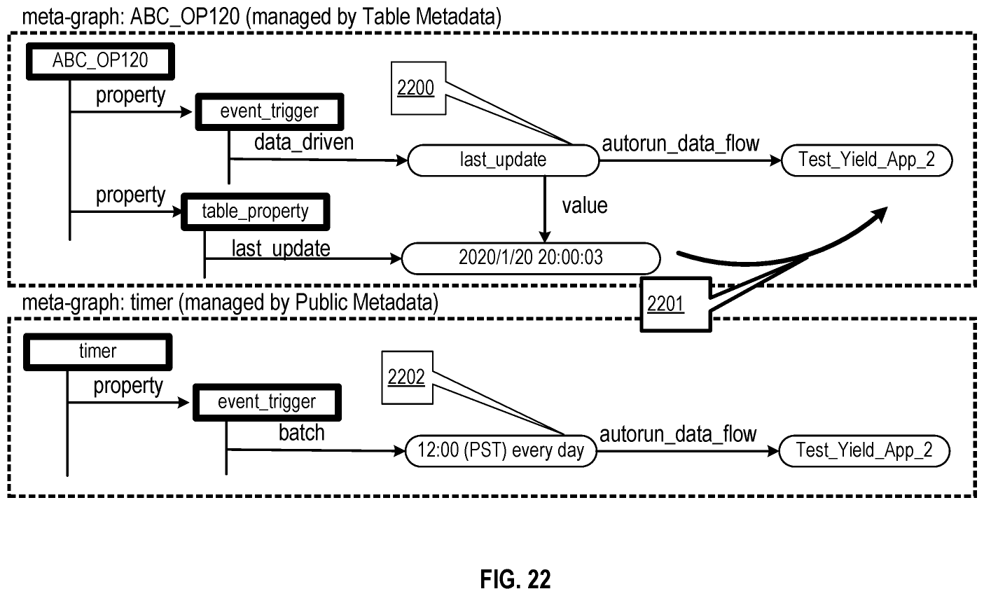

FIG. 22 illustrates an example of meta-graph with autorun settings, in accordance with an example implementation. In example implementations, the autorun engine create autorun settings in meta-graph. If the “last_update” is updated, the meta-graph management executes the data flow. The data flow execution engine executes the data flow at 2200 when meta-graph management detects an update. As shown at 2201, if the “last_update” is updated, the meta-graph management executes the data flow. Further, at 2202, the data flow execution engine executes the data flow when meta-graph management detects the specified time.

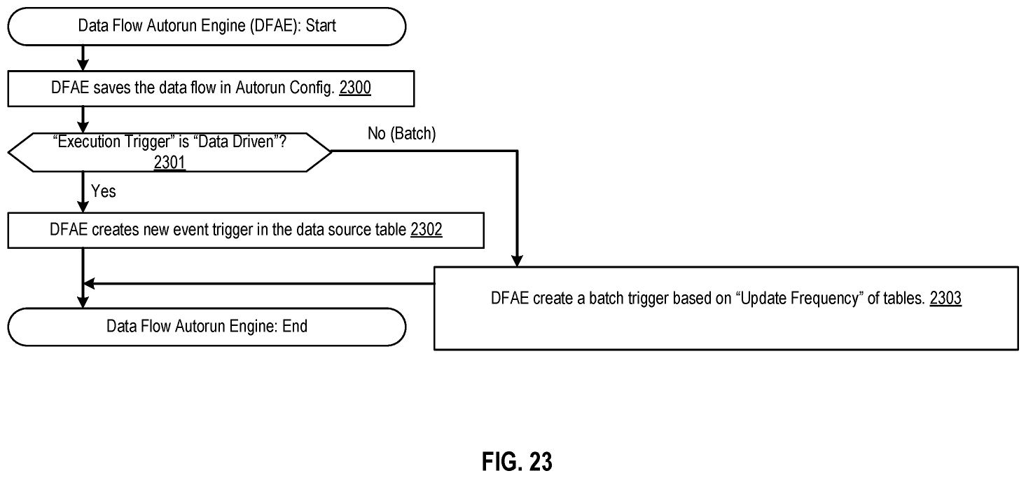

FIG. 23 illustrates an example flow diagram of the data flow autorun engine, in accordance with an example implementation. Specifically, at 2300, the data flow autorun engine saves the data flow in Autorun Config. At 2301, a determination is made as to whether the “Execution Trigger” is “Data Driven”. If so (Yes), then the flow proceeds to 2302 so that the data flow autorun engine creates a new event trigger in the data source table. Otherwise (No), the flow proceeds to 2303 wherein the data flow autorun engine create a batch trigger based on “Update Frequency” of tables. The batch trigger is the shortest period of “Update Frequency”, and the data flow autorun engine creates a new event trigger in the timer.

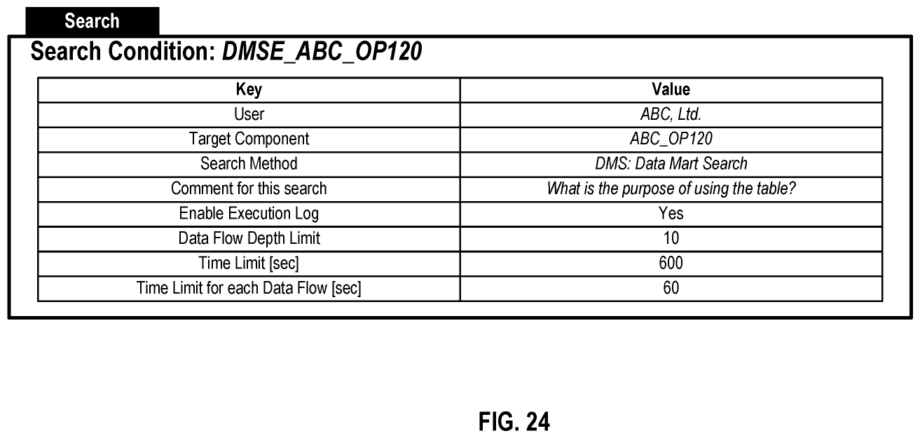

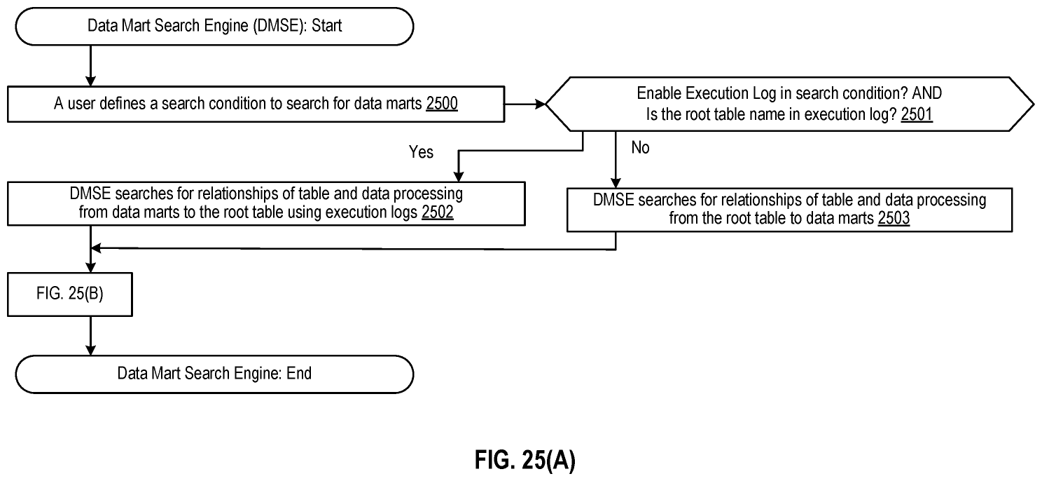

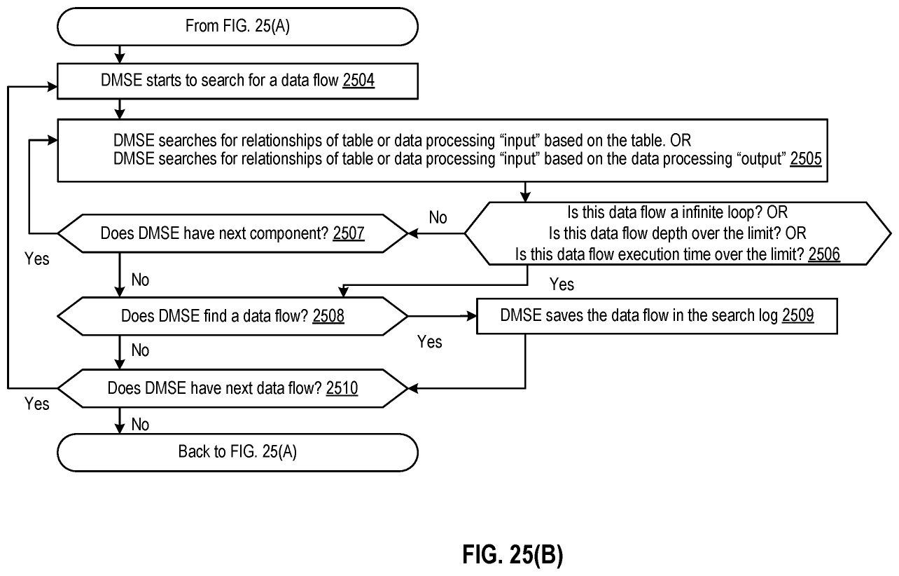

In the following explanations for FIGS. 24 to 25(B), the third scenario of FIG. 4(D) is illustrated.

FIG. 24 illustrates an example interface for the data mart search engine, in accordance with an example implementation. In the example of FIG. 24, the italicized content indicates the updates from the data source engine interface. The example of FIG. 24 shows the user setting the data mart search.

FIGS. 25(A) and 25(B) illustrate an example flow diagram for the data mart search engine, in accordance with an example implementation. Specifically, FIGS. 25(A) and 25(B) illustrate a flow wherein the data mart search engine searches for a data flow from a data source to data marts based on meta-graph. The flow is similar to the flow of the data source search engine as applied to data marts.

At first, a user defines a search condition to search for data marts at 2500. At 2501, a determination is made as to whether Execution Log is enabled in the search condition and the root table name is in the execution log. If so (Yes), the flow proceeds to 2502 wherein the data mart search engine searches for relationships of table and data processing from data marts to the root table using execution logs. Otherwise (No), the data mart search engine searches for relationships of table and data processing from the root table to data marts.

At 2504, the data mart search engine starts a loop to search for a data flow. At 2505, the data mart search engine searches for relationships of table or data processing “input” based on the table, or it searches for relationships of table or data processing “input” based on the data processing “output”.

At 2506, a determination is made as to whether the data flow is an infinite loop, the data flow depth is over the limit, or if the data flow execution time is over the limit. If so (Yes), the flow proceeds to 2508, otherwise (No) the flow proceeds to 2507.

At 2507, a determination is made as to whether there is a next component to process. If so (Yes), then the flow proceeds to 2505, otherwise (No) the flow proceeds to 2508.

At 2508, a determination is made as to whether the data mart search engine has found a data flow. If so (Yes), then the flow proceeds to 2509 to save the data flow in the search log, otherwise (No) the flow proceeds to 2510.

At 2510, a determination is made as to whether the data mart search engine has a next data flow to process. If so (Yes), then the flow proceeds back to 2504, otherwise (No), the flow ends.

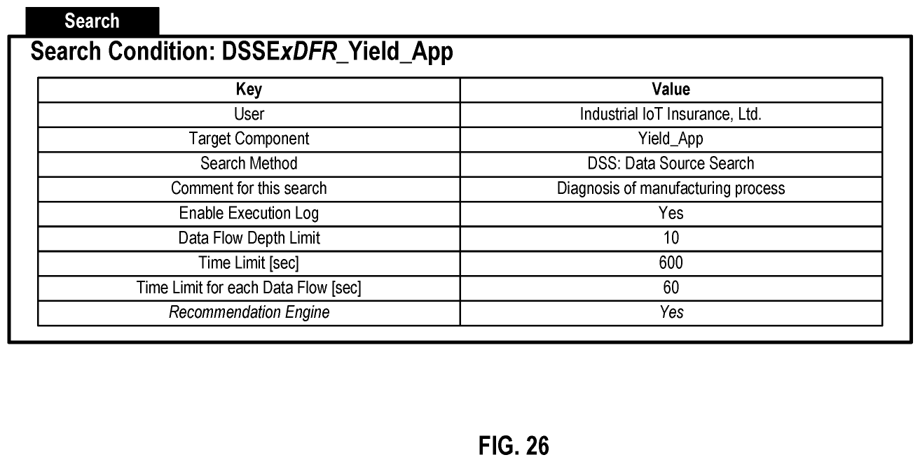

In the following example from FIGS. 26 to 29, the fourth scenario of FIG. 4(E) is illustrated.

FIG. 26 illustrates an example of a data flow recommendation engine, in accordance with an example implementation. The data flow recommendation interface is similar to the data source search engine interface with an additional data flow recommendation.

Specifically, the data flow recommendation engine recommends a data processing to connect between tables. The data flow recommendation engine searches for a triangle relationship that contain a relationship of “table A-similar→table B-input→data processing C-output→table D”. If such a relationship is detected, the data flow recommendation engine recommends a data processing to connect table A and table D, and indicates that the recommended data processing and data processing C are similar.

In the example of FIG. 26, the italicized text indicates the difference between the data flow recommendation engine from the data flow search engine. The user can set the option of “Recommendation Engine”.

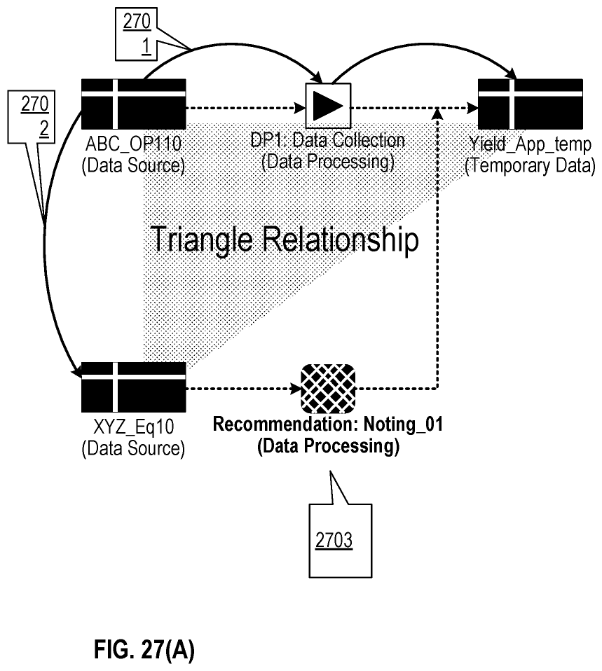

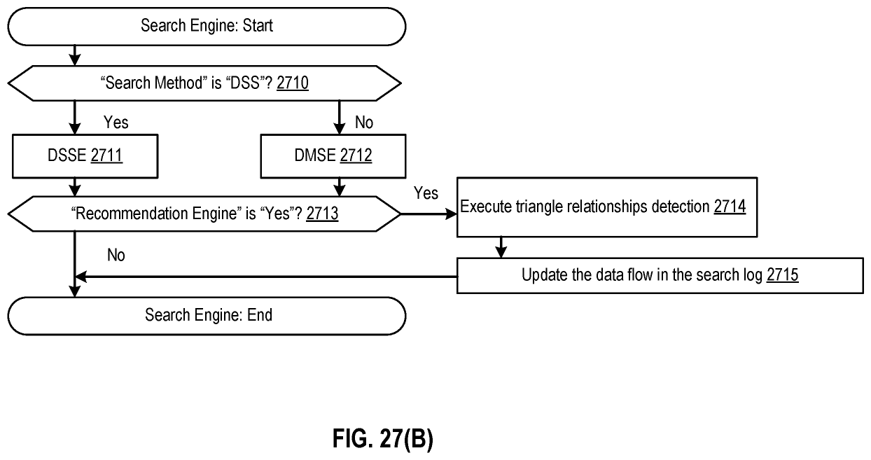

FIG. 27(A) illustrates an example of the data flow recommendation engine, in accordance with an example implementation. Specifically, FIG. 27(A) illustrates an example algorithm for the data flow recommendation engine. At 2701, the engine detects the relationships between the table and data processing. At 2702, the engine detects the relationship between similar tables. At 2703, the engine recommends a data processing to connect the data source and the temporary data. That is, the engine determines a data processing to connect the detected table and the next table of the similar table (Yield_App_temp). In this example, the data processing that is selected will be similar to DP1. The engine adds the recommendation node to generated data flows.

FIG. 27(B) illustrates an example flow diagram for the data flow recommendation engine, in accordance with an example implementation. After a search is invoked, a check is made at 2710 to determine whether the search is a data source search. If so (Yes), then the flow proceeds to 2711 to execute the data source search engine, otherwise (No), the flow proceeds to 2712 to execute the data mart search engine. At 2713, a determination is made as to whether the user requested a recommendation, if so (Yes), then the flow proceeds to 2714 to execute a triangle relationships detection process as illustrated in FIG. 27(A). At 2715, the data flow of the search log is updated.

To execute the triangle relationships detection as illustrated in FIG. 27(A), the data flow recommendation engine searches for a relationship of “table A-similar→table B-input→data processing C-ouput→table D”. If such a relationship exists, then the data flow recommendation engine recommends a data processing to connect table A and table D, and indicates that recommended data processing and data processing C are similar.

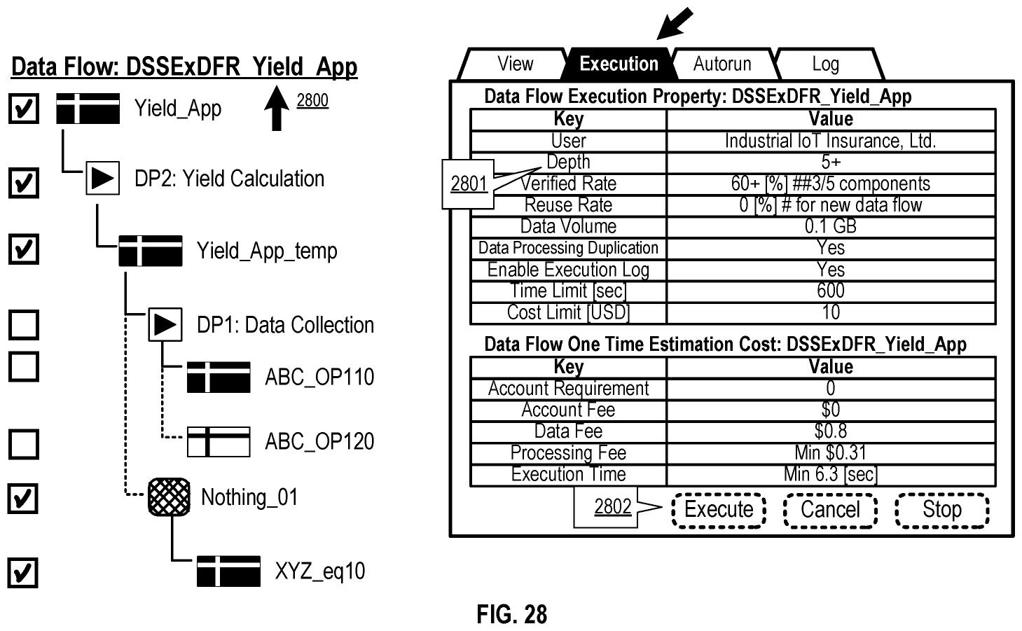

FIG. 28 illustrates an example interface of the data flow properties with the recommendation node, in accordance with an example implementation. In the example of FIG. 28, the recommendation node does not have activity logs, so the the viewer shows the estimation after the click at 2800. Further, the user cannot run a data flow because the recommendation node is not fixed in the example of FIG. 28.

In the example of FIG. 28, the viewer displays estimates if the data flow contains recommended data processing. In the example of the estimates at 2801, Nothing 01 has not been verified, so estimates are provided instead. Further, the viewer avoids the data flow execution if the data flow contains recommended data processing, as shown in the disabling of the execute button at 2802.

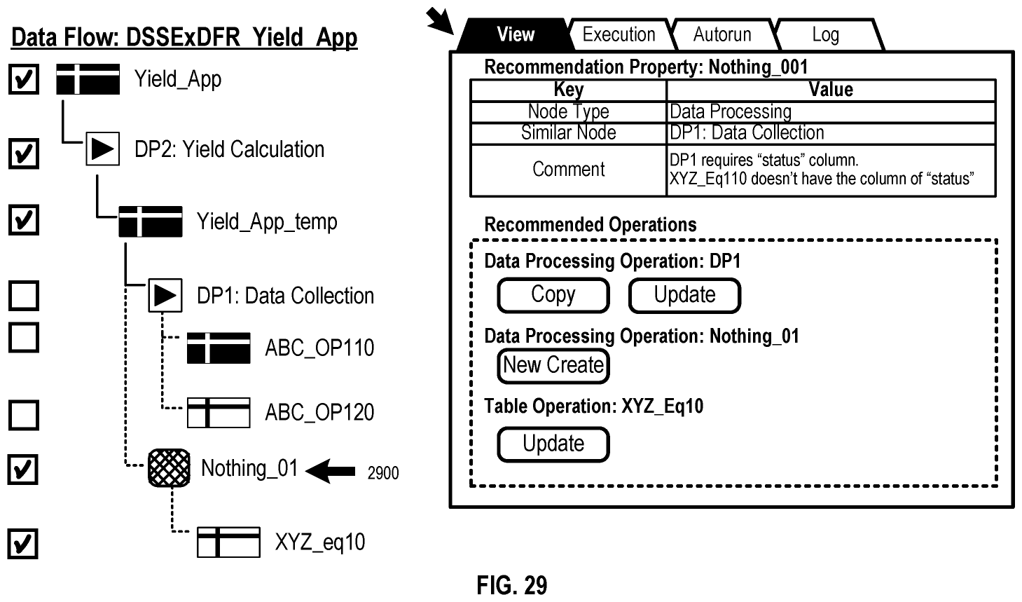

FIG. 29 illustrates an example creation of the data processing from the recommendation, in accordance with an example implementation. Specifically, in the example of FIG. 29 the user creates the data processing from the recommendation from the click at 2900. The user has four choices; the user can copy the data processing from DP1 to Nothing_01, leave a comment, update the input table of DP1 for adopting new data source, or update the table of new data source for adopting DP1. From one of these options, the user can create new data processing.

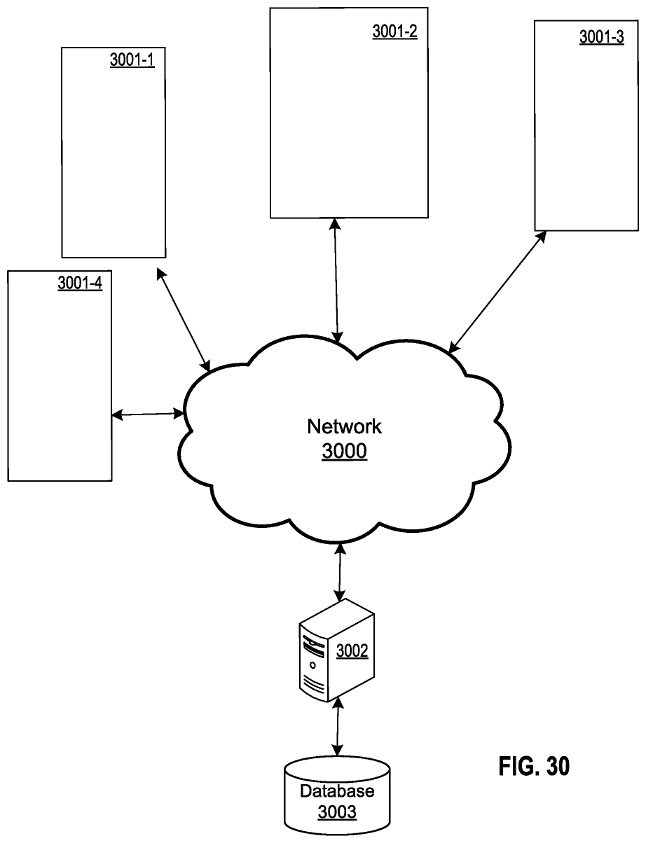

FIG. 30 illustrates a system involving a plurality of systems with connected sensors and a management apparatus, in accordance with an example implementation. One or more IoT systems with connected sensors or other data sources 3001-1, 3001-2, 3001-3, and 3001-4 are communicatively coupled to a network 3000 which is connected to a management apparatus 3002. The management apparatus 3002 can facilitate a data management platform as described herein. The management apparatus 3002 manages a database 3003, which contains historical data collected from the sensors of the systems 3001-1, 3001-2, 3001-3, and 3001-4, which can include labeled data and unlabeled data as received from the systems 3001-1, 3001-2, 3001-3, and 3001-4. In alternate example implementations, the data from the sensors of the systems 3001-1, 3001-2, 3001-3, 3001-4 can be stored to a central repository or central database such as proprietary databases that intake data such as enterprise resource planning systems, and the management apparatus 3002 can access or retrieve the data from the central repository or central database. Such IoT systems can include systems with databases for data received from edge devices, streaming data from robot arms with sensors, turbines with sensors, lathes with sensors, and so on in accordance with the desired implementation.

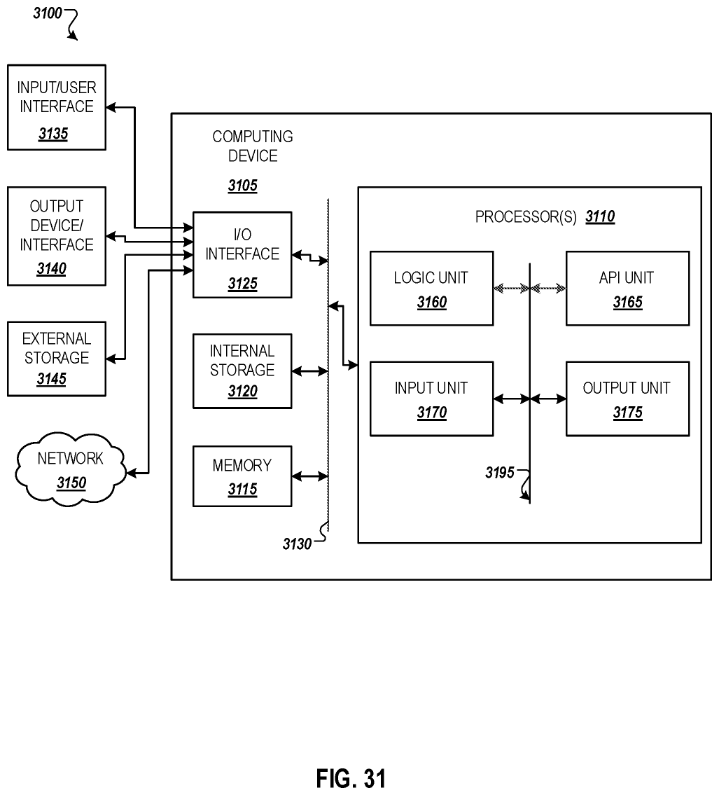

FIG. 31 illustrates an example computing environment with an example computer device suitable for use in some example implementations, such as a management apparatus 3002 as illustrated in FIG. 30.

Computer device 3105 in computing environment 3100 can include one or more processing units, cores, or processors 3110, memory 3115 (e.g., RAM, ROM, and/or the like), internal storage 3120 (e.g., magnetic, optical, solid state storage, and/or organic), and/or I/O interface 3125, any of which can be coupled on a communication mechanism or bus 3130 for communicating information or embedded in the computer device 3105. I/O interface 3125 is also configured to receive images from cameras or provide images to projectors or displays, depending on the desired implementation.

Computer device 3105 can be communicatively coupled to input/user interface 3135 and output device/interface 3140. Either one or both of input/user interface 3135 and output device/interface 3140 can be a wired or wireless interface and can be detachable. Input/user interface 3135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 3140 may include a display, television, monitor, printer, speaker, braille, or the like. In some example implementations, input/user interface 3135 and output device/interface 3140 can be embedded with or physically coupled to the computer device 3105. In other example implementations, other computer devices may function as or provide the functions of input/user interface 3135 and output device/interface 3140 for a computer device 3105.

Examples of computer device 3105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 3105 can be communicatively coupled (e.g., via I/O interface 3125) to external storage 3145 and network 3150 for communicating with any number of networked components, devices, and systems, including one or more computer devices of the same or different configuration. Computer device 3105 or any connected computer device can be functioning as, providing services of, or referred to as a server, client, thin server, general machine, special-purpose machine, or another label.

I/O interface 3125 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 3100. Network 3150 can be any network or combination of networks (e.g., the Internet, local area network, wide area network, a telephonic network, a cellular network, satellite network, and the like).

Computer device 3105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 3105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 3110 can execute under any operating system (OS) (not shown), in a native or virtual environment. One or more applications can be deployed that include logic unit 3160, application programming interface (API) unit 3165, input unit 3170, output unit 3175, and inter-unit communication mechanism 3195 for the different units to communicate with each other, with the OS, and with other applications (not shown). The described units and elements can be varied in design, function, configuration, or implementation and are not limited to the descriptions provided.

In some example implementations, when information or an execution instruction is received by API unit 3165, it may be communicated to one or more other units (e.g., logic unit 3160, input unit 3170, output unit 3175). In some instances, logic unit 3160 may be configured to control the information flow among the units and direct the services provided by API unit 3165, input unit 3170, output unit 3175, in some example implementations described above. For example, the flow of one or more processes or implementations may be controlled by logic unit 3160 alone or in conjunction with API unit 3165. The input unit 3170 may be configured to obtain input for the calculations described in the example implementations, and the output unit 3175 may be configured to provide output based on the calculations described in example implementations.

Processor(s) 3110 can be configured to facilitate a meta-graph management configured to link external data source to another external data mart through a data management platform, which can involve managing characteristics of one or more tables of the data source and the data mart and a temporary table based on columns; managing characteristics of one or more input data and output data of data processing from the data source to the data mart based on columns; managing relationships of characteristics between data and data processing for the data source and the data mart based on the columns; managing one or more data flows between the data source and the data mart that include data, data processing, and relationships; and providing data, data processing, and relationships between the data source and the data mart for each data flow as illustrated from FIGS. 4(A) to 8.

Processor(s) 3110 can be configured to create the one or more data flows based on a data search from the data mart to the data source and from the data source to the data mart; and provide the one or more data flows and usage records for each component in the data management platform as illustrated in FIGS. 2, 9 to 11(B), and 25(A) to 25(B). The creation of the one or more data flows based on the data search can involve searching execution logs of components on the data management platform to determine the one or more data flows as illustrated in FIGS. 9 to 11(B). The searching of the execution logs can involve retrieving, from execution logs corresponding to target data associated with the data search, the one or more data flows related to target data associated with the data search as illustrated in FIGS. 9 to 11(B).

Processor(s) 3110 can be configured to manage, for each component on the data management platform, usage information, total cost, estimated cost, and estimated execution statistics based on execution logs associated with the each component, and provide an interface configured to provide the usage information, total cost, estimated cost, and estimated execution statistics for the each component as illustrated in FIGS. 2, 12 to 16 and 19 to 21.

Processor(s) 3110 can be configured to create isolated data spaces for each of the one or more data flows; and for execution of a data flow from the one or more dataflows, execute the data flow through using an associated one of the isolated data spaces as illustrated in FIG. 18.

Processor(s) 3110 can be configured to, for the data processing being enabled for data processing duplication and for the each data flow being duplicable, duplicate the data processing as illustrated in FIGS. 17 to 19.

Processor(s) 3110 can be configured to, for the each data flow being incomplete, not execute the data flow as illustrated in FIG. 28.

Processor(s) 3110 can be configured to add event definitions based on an autorun property as illustrated in FIGS. 21 to 24.

Processor(s) 3110 can be configured to, for other data sources being similar to the data source, recommend the data processing used in the data flow between data source and the data mart for the other data sources; and manage a plurality of properties for the recommended data processing for the other data sources as illustrated in FIGS. 26 to 29.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the embodiments are not described with reference to any particular programming language. It will be appreciated that a variety of programming languages may be used to implement the teachings of the embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the embodiments may be implemented using circuits and logic devices (hardware), while other aspects may be implemented using instructions stored on a machine-readable medium (software), which if executed by a processor, would cause the processor to perform a method to carry out implementations of the present application. Further, some embodiments of the present application may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described embodiments may be used singly or in any combination. It is intended that the specification and embodiments be considered as examples only, with the true scope and spirit of the present application being indicated by the following claims.

1. A method for a meta-graph management configured to link external data source to another external data mart through a data management platform, the method comprising:
managing, by a processor, characteristics of one or more tables of the data source and the data mart and a temporary table based on columns;
managing, by a processor, characteristics of one or more input data and output data of data processing from the data source to the data mart based on columns;
managing, by the processor, relationships of characteristics between data and data processing for the data source and the data mart based on the columns;
managing, by a processor one or more data flows between the data source and the data mart that include data, data processing, and relationships;
providing, by the processor, data, data processing, and relationships between the data source and the data mart for each data flow;
managing, by the processor, for each component in the data management platform, usage information, cost, estimate, and statistics based on execution logs associated with the each component; and
providing, by a processor, an interface configured to provide the usage information, the cost the estimate, and the statistics for the each component.

2. The method of claim 1, further comprising, creating, by the processor, the one or more data flows based on a data search from the data mart to the data source and from the data source to the data mart; and
providing, by the processor, the one or more data flows and usage records for the each component in the data management platform.

3. The method of claim 2, wherein the creating the one or more data flows based on the data search comprises searching execution logs of components on the data management platform to determine the one or more data flows.

4. The method of claim 3, wherein for the searching of the execution logs comprises retrieving, from execution logs corresponding to target data associated with the data search, the one or more data flows related to target data associated with the data search.

5. (canceled)

6. The method of claim 1, further comprising:
creating, by the processor, isolated data spaces for each of the one or more data flows; and
for execution of a data flow from the one or more dataflows, executing, by the processor, the data flow through using an associated one of the isolated data spaces.

7. The method of claim 1, further comprising, for the data processing being enabled for data processing duplication and for the each data flow being duplicable, duplicating, by a processor, the data processing.

8. The method of claim 1, further comprising, for the each data flow being incomplete, not executing the data flow.

9. The method of claim 1, further comprising adding, by the processor, event definitions based on an autorun property.

10. The method of claim 1, further comprising, for other data sources being similar to the data source, recommending, by the processor, the data processing used in the data flow between data source and the data mart for the other data sources; and
managing, by the processor, a plurality of properties for the recommended data processing for the other data sources.

11. A non-transitory computer readable medium, storing instructions for execution by one or more processors for a meta-graph management configured to link external data source to another external data mart through a data management platform, the instructions comprising:
managing, by a processor, characteristics of one or more tables of the data source and the data mart and a temporary table based on columns;
managing, by a processor, characteristics of one or more input data and output data of data processing from the data source to the data mart based on columns;
managing, by a processor, relationships of characteristics between data and data processing for the data source and the data mart based on the columns;
managing, by the processor, one or more data flows between the data source and the data mart that include data, data processing, and relationships;
providing, by the processor, data, data processing, and relationships between the data source and the data mart for each data flow;
managing, by the processor, for each component in the data management platform, usage information, cost, estimate, and statistics based on execution logs associated with the each component; and
providing, by a processor, an interface configured to provide the usage information, the cost the estimate, and the statistics for the each component.

12. The non-transitory computer readable medium of claim 11, the instructions further comprising, creating, by the processor, the one or more data flows based on a data search from the data mart to the data source and from the data source to the data mart; and
providing, by the processor, the one or more data flows and usage records for the each component in the data management platform.

13. The non-transitory computer readable medium of claim 12, wherein the creating the one or more data flows based on the data search comprises searching execution logs of components on the data management platform to determine the one or more data flows.

14. The non-transitory computer readable medium of claim 13, wherein for the searching of the execution logs comprises retrieving, from execution logs corresponding to target data associated with the data search, the one or more data flows related to target data associated with the data search.

15. (canceled)

16. The non-transitory computer readable medium of claim 11,
the instructions further comprising:
creating, by the processor, isolated data spaces for each of the one or more data flows; and
for execution of a data flow from the one or more dataflows, executing, by the processor, the data flow through using an associated one of the isolated data spaces.

17. The non-transitory computer readable medium of claim 11, the instructions further comprising, for the data processing being enabled for data processing duplication and for the each data flow being duplicable, duplicating, by the processor the data processing.

18. The non-transitory computer readable medium of claim 11, the instructions further comprising, for the each data flow being incomplete, not executing the data flow.

19. The non-transitory computer readable medium of claim 11, further comprising adding, by the processor, event definitions based on an autorun property.

20. The non-transitory computer readable medium of claim 11, further comprising, for other data sources being similar to the data source, recommending, by the processor, the data processing used in the data flow between data source and the data mart for the other data sources; and
managing, by the processor, a plurality of properties for the recommended data processing for the other data sources.
